(19) United States
(12) Patent Application Publication
(10) Pub. No.: US 2022/0147442 A1
(43) Pub. Date: May 12, 2022

(54) METHOD FOR THE EXECUTION OF A COMPUTER PROGRAM BY AN ELECTRONIC COMPUTING DEVICE COMPRISING A MAIN MEMORY AND A SECONDARY MEMORY

(71) Applicant: Commissariat à l'Energie Atomique et aux Energies Alternatives, Paris (FR)

(72) Inventors: Riyane SID LAKHDAR, Grenoble Cedex 9 (FR); Henri-Pierre CHARLES, Grenoble Cedex 9 (FR); Maha KOOLI, Grenoble Cedex 9 (FR)

(73) Assignee: Commissariat à l'Energie Atomique et aux Energies Alternatives, Paris (FR)

(21) Appl. No.: 17/453,690

(22) Filed: Nov. 5, 2021

(30) Foreign Application Priority Data
Nov. 6, 2020 (FR) 20 11394

(51) Int. Cl. G06F 12/02; G06F 12/06; G06F 8/41

(52) U.S. Cl. CPC G06F 12/0238; G06F 8/41; G06F 12/0284; G06F 12/0623

(57) ABSTRACT

A computing device divides an area of a main memory wherein a data structure is saved into NbS1 subdivisions, and then the computing device computes a weight w_{S,NbS1}(k) for each of the NbS1 subdivisions using the following relationship: w_{S,NbS1}(k)=P_{S}(1+(k−1)×(NbS0−1)/(NbS1−1)), where: k is the order number k of one of the NbS1 subdivisions, and P_{S}( ) is a predetermined function that is continuous over an interval [1; NbS0] and defined over each interval [k₀, k₀+1] by a polynomial of order less than four, where k₀ is an integer order number contained in the interval [1; NbS0], and then when a datum D_{k,n} contained in a subdivision k of the main memory has to be transferred to a secondary memory, the computing device transfers a block of w_{S,NbS1}(k) data containing the datum D_{k,n} where w_{S,NbS1}(k) is the weight computed for this subdivision k.

The invention relates to a method for the execution of a computer program by an electronic computing device comprising a main memory and a secondary memory. The invention also relates to:
a method for compiling a source code of a computer program for a computing device comprising a main memory and a secondary memory,
an information storage medium for implementing these methods, and
a compiler.

The computer program in question is typically a computer program on the “user level”. “User level” is the conventional term used in computing. The user level is different from the “system level”. The system level is also known as the “kernel level”.

In this case, the compilation methods in question are notably compilation methods that comprise a step of transforming an initial source code into an optimized source code that is then compiled in order to obtain the executable code of the computer program.

Hereinafter in this text, the term “computer program” is used as a generic term and may therefore refer both to the source code of this computer program and to the executable code of this computer program.

The expression “accessing a datum” refers to the act of reading and/or writing a datum from and/or to the memory. Such operations of reading and/or writing a datum may, if necessary, cause this datum to be transferred between two different memories of a computing device.

A secondary memory is a memory that is physically distinct from the main memory. In addition, this secondary memory corresponds, in the address space of the computer program, to an address range that is distinct from the address range corresponding to the main memory. The secondary memory is thus used during the execution of the computer program only if the executable code of this computer program comprises:
instructions that handle the transfer of data between the main memory and the secondary memory, and
access instructions for accessing the secondary memory.

The access instructions for accessing the secondary memory comprise, as an operand, a virtual address within the address range of the address space of the computer program that corresponds specifically to the secondary memory.

In terms of this, a secondary memory is different from cache memories and other similar memories that are handled automatically by the operating system and/or a micro-computing device specifically dedicated to this function. Specifically, to benefit from the presence of such cache memories, the computer program that is executed does not need to comprise instructions that handle the transfer of data between the main memory and the cache memories and to comprise access instructions for accessing the cache memories. In addition, unlike a secondary memory, a cache memory does not correspond to an address range, in the address space of the computer program, that is different from the address range of the main memory.

Thus, in order to use a secondary memory, the developer has to manually introduce the following into the source code of the computer program:
instructions for transferring data between the main memory and the secondary memory, and
access instructions for accessing the secondary memory.

In general, data are transferred between the main memory and the secondary memory in blocks of data in order to limit the number of times the electronic computing device has to execute these transfer instructions. The size of the blocks that are transferred is an important parameter for adjusting the number of data transfers between the main memory and the secondary memory. The size of the data blocks is thus a parameter that makes it possible to achieve a measurable performance level of the electronic computing device. For example, the measured performance is the execution speed of the computer program or the power consumption of the electronic computing device.

It is possible, for example experimentally, to determine, for a data structure S of size Dim0, a size w_{S,Dim0} for the transferred data blocks that corresponds to a desired performance level. This size w_{S,Dim0} is strongly dependent on the size of the data structure, and therefore on its size Dim0. In other words, a size w_{S,Dim0} that makes it possible to achieve the desired performance level when the data structure is of size Dim0 does not necessarily make it possible to keep the same performance level when the same data structure S has a different size Dim1. This is even the most common case in practice.

In some computer programs, the size of the data structure is known only when it is executed, and not when the computer program is compiled. In this case, it is not generally possible to find a size w_{S,Dim0} that keeps substantially the same performance level for a large number of different sizes of the data structure.

The following articles deal with the transfer of data between a main memory and a secondary memory, known by the acronym SPM (“ScratchPad Memory”):
Kandemir M et al.: “Dynamic management of scratch-pad memory space”, Proceedings of the 38th, annual design automation conference, Las Vegas, Jun. 18-22, 2001; pages 690-695, and
Doosan Cho et al.: “Adaptive Scratch Pad Memory Management for Dynamic Behavior of Multimedia Applications”, IEEE Transactions on computer aided design of integrated circuit and systems, vol. 28, no. 4, 1 Apr. 2009, pages 554-567.
   The article by Kandemir M et al. discloses a compiler that makes it possible to automatically introduce instructions to transfer data between the main memory and the SPM memory. The article by Doosan Cho et al. discloses a module that makes it possible, when the computer program is executed, to determine which data are to be transferred from the main memory to the SPM memory. None of these articles provides any solution that makes it possible to keep the performance level of the computing device substantially constant, and to do so in spite of a change in the size of the matrices processed by the computer program that is executed.

The following article describes a method for automatically determining, for each processed data structure, an optimized layout of the data of these structures in the main memory: Riyane Sis Lakhdar et al.: “Data-layout optimization based on memory-access-pattern analysis for source-code performance improvement”, Proceedings of the 23rd International Workshop on Software and Compilers for Embedded Systems, 25 May 2020, pages 1-6.

The invention aims to propose a solution that makes it possible to keep the performance level of the electronic computing device substantially constant, even when the size of the data structure varies.

One subject of the invention is therefore a method for executing a computer program.

Another subject of the invention is a method for compiling a source code.

Another subject of the invention is an information storage medium, able to be read by a microprocessor, this medium comprising instructions for the execution of one of the above methods when these instructions are executed by the microprocessor.

Finally, another subject of the invention is a compiler.

The invention will be better understood on reading the following description, which is given solely by way of non-limiting example, with reference to the drawings, in which:

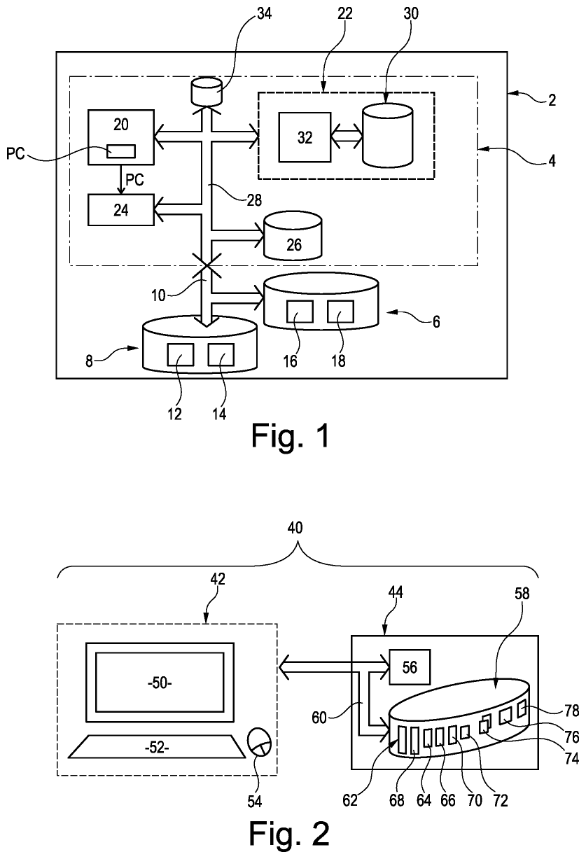

FIG. 1 is a schematic illustration of the architecture of a computing unit incorporating an electronic computing device;

FIG. 2 is a schematic illustration of the architecture of a compiler;

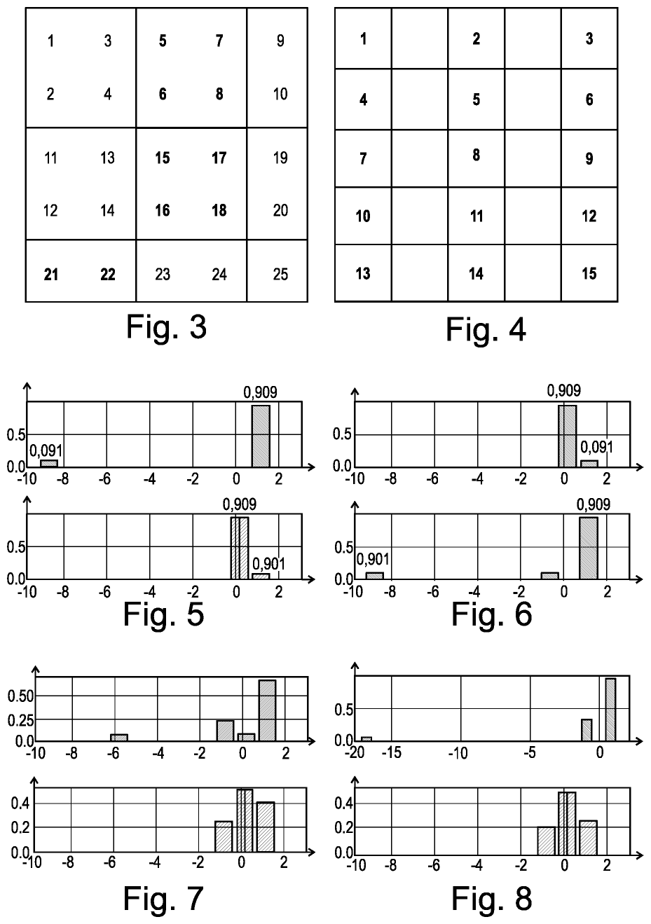

FIGS. 3 and 4 are schematic illustrations of possible traversals of a matrix;

FIGS. 5 to 8 are illustrations of model signatures used by the compiler of FIG. 2;

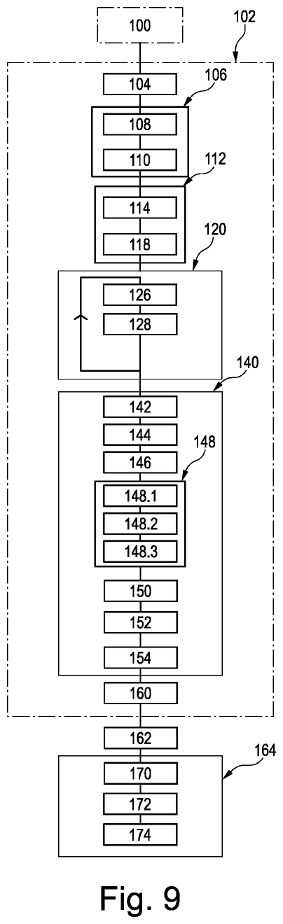

FIG. 9 is a method for compiling a source code using the compiler of FIG. 2 and for the execution of the executable code thus obtained by the computing unit of FIG. 1;

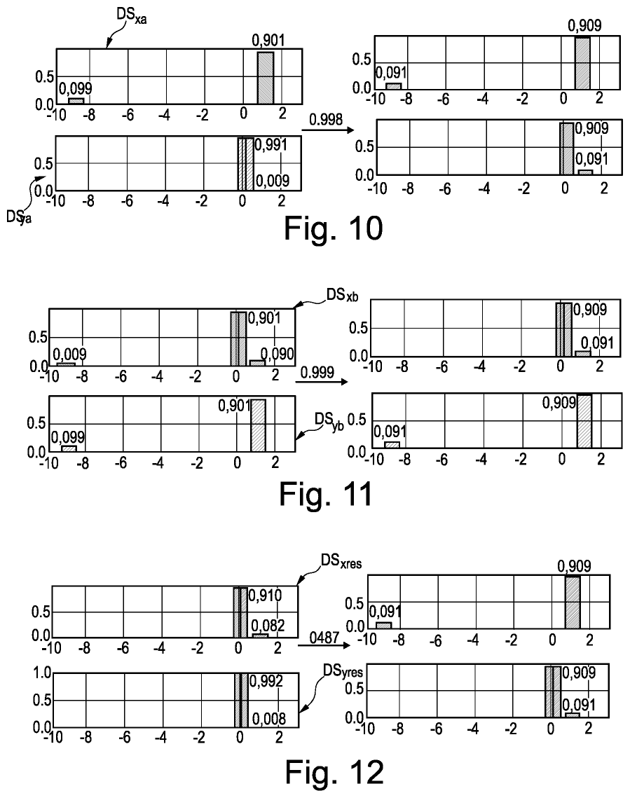

FIGS. 10 to 12 illustrate the comparison of constructed signatures with model signatures in the implementation of the method of FIG. 9;

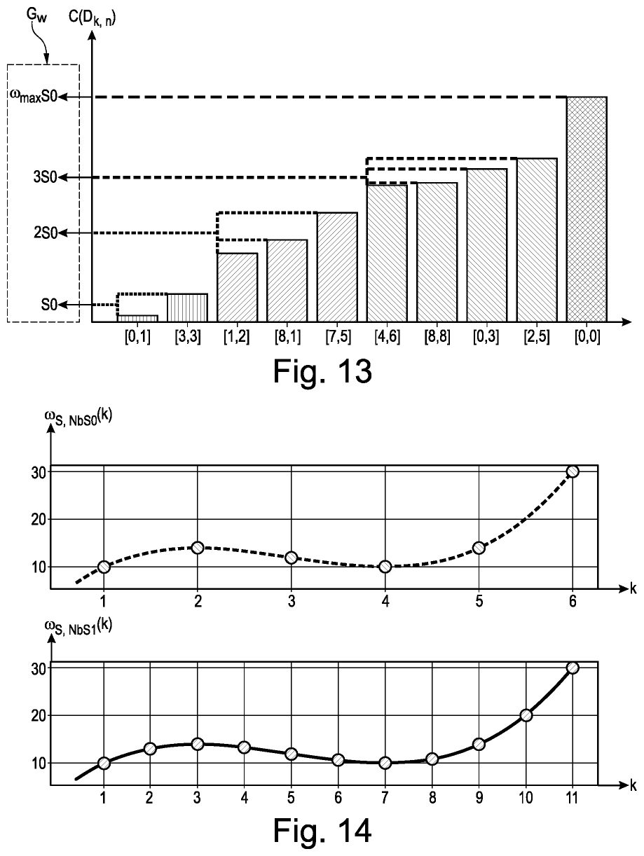

FIG. 13 is a graph illustrating the functioning of an operation of assigning intermediate weights to data, implemented in the method of FIG. 9;

FIG. 14 is a graph illustrating the functioning of a procedure of computing weights, implemented in the method of FIG. 9.

In these figures, the same references are used to denote elements that are the same. In the remainder of this description, features and functions that are well known to those skilled in the art are not described in detail.

In this description, a detailed example of the compilation and execution of a computer program optimized for a target computing device comprising a secondary memory is first described in section I with reference to FIGS. 1 to 14. Following section II then describes various variants of the embodiment described in the previous section. Finally, the advantages of the various embodiments are presented in a final section Ill.

### Section I: Optimized Compilation and Execution of a Computer Program for a Computing Device Comprising a Secondary Memory

One example of a possible hardware architecture for an electronic computing device incorporated into a computing unit is first described, and then the compiler and the method for compiling and executing the computer program are described.

FIG. 1 shows an electronic computing unit 2. For example, the unit 2 is a computer, a smartphone, a tablet computer, an engine control unit or the like. The hardware structure of such a unit 2 is well known and only the elements required for understanding the invention are shown and described in greater detail. The unit 2 comprises:

a programmable electronic computing device 4,

a main memory 6,

a non-volatile memory 8, and

a bus 10 for transferring data between the memories 6, 8 and the computing device 4.

The computing device 4 is capable of executing an executable code of a computer program obtained after compilation of a source code of this computer program. In this case, the computer program is a program on the user level.

The memory 6 is typically a quick-access memory that the computing device 4 accesses more quickly than the memory 8. In this case, the memory 6 is a random-access memory. It may be a volatile memory such as a DRAM (“dynamic random-access memory”). The memory 6 may also be a non-volatile random-access memory such as a flash memory.

The memory 8 is for example a hard disk or any other type of non-volatile memory. The memory 8 comprises an executable code 12 of a computer program. The code 12 is capable of being executed by the computing device 4. The memory 8 may also comprise data 14 to be processed by this program when it is executed. When the executable code 12 is executed by the computing device 4, the instructions of the code 12 and the data 14 are first transferred to the memory 6 for quicker access thereto. In the memory 6, the instructions of the executable code 12 and the data 14 processed by this program bear the reference numerals 16 and 18, respectively.

When it is executed, the executable code 12 processes structured data. A structured datum is a data structure. A data structure is a structure that groups a plurality of data within a continuous virtual address range in the address space of the computer program that is executed. The address space of the computer program consists of the set of addresses that may be used as an operand of an access instruction for accessing the memory in the computer program. An access instruction is typically an instruction for the computing device 4 to write or to read a datum to or from the executable memory.

Within the continuous address range of a data structure, the data are placed in relation to one another according to a predetermined layout. Under these conditions, the position of a datum within a data structure is identified by one or more indices. Thus, on the basis of the knowledge of a base address of the data structure and of the values of the indices that identify the position of a datum within this data structure, it is possible to construct the virtual address of this datum in the address space of the computer program. Using this virtual address, each datum of the data structure may directly be accessed individually. This datum may thus be read or written independently of the other data of the data structure. The base address of a data structure is for example the virtual address at which this data structure begins or ends.

There are a large number of possible data structures, such as a matrix with one or more dimensions or an object in object-oriented programming or the like. Given that one of the most commonly used data structures is a two-dimensional matrix, the main detailed exemplary embodiments are given in the particular case where the data structure is a two-dimensional matrix. However, the teaching provided in this particular case is transposed easily to other data structures.

In the case of a matrix, the position of each datum within the matrix is identified using indices. Conventionally, in the case of a two-dimensional matrix, these indices are called “row number” and “column number”. The processing of such data structures by the executable code 12 involves numerous access operations to the data of this data structure.

The computing device 4 comprises:

a microprocessor 20, also known by the acronym CPU (“central processing unit”),

a cache memory 22,

a preloading module 24, also known as a “prefetcher”,

a buffer 26,

a secondary memory 34, and

a bus 28 for transferring data between the microprocessor 20, the memory 22, the module 24, the buffer 26, the memory 34 and the bus 10.

The microprocessor 20 is capable of executing the executable code 12. To this end, it furthermore comprises a register PC called a program counter or instruction pointer that contains the address of the instruction currently being executed or of the next instruction to be executed by the microprocessor 20.

The cache memory 22 is in this case a cache memory with one or more levels. In this example, the cache memory 22 is a cache memory with three levels. In this case, the three levels are known as, respectively, level L1, level L2 and level L3. The cache memory 22 makes it possible to store data that the microprocessor 20 is able to access more quickly than if they were to have been stored only in the memory 6.

For level L1, the memory 22 comprises a memory 30 and a micro-computing device 32. The memory 30 contains data that the microprocessor 20 is able to access more quickly without having to read them from the memory 6. The micro-computing device 32 manages the saving and the erasure of data in the memory 30. In particular, when a new datum has to be saved in the memory 30, the micro-computing device 32 determines, using an algorithm specific thereto, the one or more data to be erased from the memory 30 in order to free up the space required to save this new datum in the cache memory 22.

The architecture of the other levels L2 and L3 is similar and has not been shown in FIG. 1.

The module 24 has the function of predicting, before the microprocessor 20 needs it, the location of the data to be preloaded into the cache memory 22 and then of triggering the preloading of these data. To this end, the module 24 may comprise a micro-computing device dedicated to this function. In this case, it comprises its own memory containing the instructions required to execute a preloading method and its own microprocessor that executes these instructions. It may also be a dedicated integrated circuit. In this case, the instructions of the preloading method are hard-wired into this integrated circuit.

The memory 26 is in this case a buffer used by the module 24 for temporarily saving the one or more data to be preloaded there before they are transferred, if necessary, to the cache memory 22.

In the case of the computing device 4, transferring a complete word or a complete row from the memory 6 to the buffer 26 does not take any more time than transferring just the datum to be preloaded. In addition, transferring a complete word or a complete row also allows the occurrence of cache errors to be limited. Thus, in the case of the computing device 4, it is preferable for the data of a data structure loaded into the memory 22 to be accessed in the same order as the order in which they are saved in the cache memory 22. Specifically, this limits cache errors, and this therefore considerably speeds up the execution of the executable code 12.

It is pointed out at this juncture that the layout of the data structure that makes it possible to speed up the execution of the executable code depends notably on the computer program that is executed and on the hardware architecture of the computing device 4.

In this text, “layout of a data structure” is understood to mean the layout of the data of this data structure in the main memory. In particular, this therefore means:

the layout of the various data of the data structure in relation to one another, and

the location where the data structure is saved in the one or more memories of the target computing device.

The computer program determines the temporal order in which the data of the data structure are accessed. A layout of a data structure optimized for one particular computer program is thus not necessarily optimum for another computer program. For example, an in-memory layout of a matrix optimized for a first computer program that accesses this matrix row by row is not optimized for a second computer program that accesses this same matrix column by column. An “optimized layout” here is understood to mean a layout of the data of the data structure in the memory that improves a predefined performance of the target computing device. This predefined performance is a physical quantity able to be measured using an electronic sensor. In this embodiment, the predefined performance is the execution speed of the computer program. The execution speed is measured by counting the number of clock cycles of the microprocessor between the time when the execution of the program begins and the time when this execution ends.

In this case, the memory 34 is called a “secondary” memory since access to this memory 34 is managed directly and solely by the computer program that is executed. To this end, the memory 34 corresponds to a specific address range in the address space of the computer program. Thus, when the computing device executes an access instruction for accessing a datum whose address is located in this specific range, this causes a write operation or a read operation directly to or from the memory 34. Likewise, the transfer of data between the main memory 6 and the secondary memory 34 is caused by the execution of access instructions located in the executable code of the computer program. In other words, in the absence of any access instruction for accessing the memory 34 in the code of the executed program, no datum processed by this computer program is written to or read from the memory 34. Thus, at present, it is up to the developer who writes the computer program to himself introduce the access instructions for accessing the memory 34 into the source code of the computer program so as to speed up the execution of this computer program by the computing device 4. This is often a task that is difficult to perform.

On this point, the memory 34 differs from cache memories and other buffers used to speed up access to the data of the main memory 6. Specifically, as explained above, the writing and reading of data to and from the cache memory 22 or to and from the buffer 26 are not explicitly managed by the computer program. There is no address in the address space of the computer program that corresponds specifically to one of these memories 22 and 26. The computer program is therefore not aware of the existence of the cache memory 22 and of the buffer 26, and it does not manage the writing and reading of data to and from these memories 22 and 26 itself.

Conversely, the main memory 6 itself also corresponds to an address range in the address space of the computer program. Therefore, in the same way as for the secondary memory, the code of the computer program may comprise access instructions parameterized with a virtual address located in this range that corresponds to the main memory 6. When the microprocessor 20 executes such an access instruction for accessing the memory 6, this causes an access operation:

to the main memory 6 if the datum is not already in the cache memory 22 or the buffer 26, or

to the cache memory 22 if the datum is already located in the cache memory 22, or

to the buffer 26 if the datum is already located in the buffer 26.

In this case, it is the micro-computing device 32, the module 24 and the operating system that determine whether the datum corresponding to this address should be accessed in the memory 22 or in the memory 26 or in the main memory 6. It is therefore other elements outside the executed computer program that manage access operations to these memories 22 and 26. Thus, unlike the memory 34, the memories 22 and 26 do not correspond, within the address space of the computer program, to address ranges distinct from the address range corresponding to the memory 6.

In this case, the memory 34 is mechanically distinct from the main memory 6, from the cache memory 22 and from the buffer 26. The memory 34 has features and advantages that the main memory 6 does not have. In this case, by way of example, it is faster than any of the memories 6, 22 and 26. “Faster memory” is understood to mean that the time to read or write a datum from or to this memory is shorter than the time required to read or write a datum from or to the cache memory 22. For example, the memory 34 is a memory known by the acronym SPM (“ScratchPad Memory”).

Under the command of the microprocessor 20, the bus 28 makes it possible to directly transfer data from the memory 6 to the memory 34 and vice versa. For example, in this embodiment, the width of the bus 28 is sufficient to allow the simultaneous transfer of four data from the memory 6 to the memory 34 and vice versa. By way of example, in this description, the bus 28 is a 128-bit bus.

FIG. 2 shows a compiler 40 capable of generating an executable code of an optimized computer program for the computing device 4. To this end, the compiler 40 automatically introduces access instructions for accessing the memory 34 in order to generate an executable code that, when it is executed by the computing device 4, uses the memory 34 to speed up its execution. The compiler 40 thus improves the performance of the computing device 4 by using the memory 34. By contrast, the compiler 40 in no way modifies the algorithm developed by the developer who wrote the source code. In particular, the compiler 40 does not modify the order in which the access instructions for accessing the data are executed.

To this end, the compiler 40 comprises:

a human-machine interface 42, and

a central processing unit 44.

The human-machine interface 42 comprises, for example, a screen 50, a keyboard 52 and a mouse 54 that are connected to the central processing unit 44.

The central processing unit 44 comprises a microprocessor 56 and a memory 58, and a bus 60 for exchanging information, connecting the various elements of the compiler 40 to one another.

The microprocessor 56 is capable of executing the instructions saved in the memory 58. The memory 58 comprises:

an initial source code 62 of the computer program to be compiled,

the instructions of a non-optimized compilation module 64,

the instructions of an optimized compilation module 66,

the instructions of a module 68 for retrieving access patterns,

the instructions of a module 70 for constructing signatures characteristic of access to the memory,

the instructions of a module 72 for constructing a numerical function P_{S}(x) for computing weights, and

a database 74 of optimized data structure codings.

The source code 62 is a source code that, after compilation, corresponds to an executable code that processes and manipulates data structures when it is executed by the computing device 4. To this end, the source code 62 contains notably:

declarations of one or more data structures whose sizes are acquired during the execution of the computer program,

access instructions for accessing the data of the declared data structures, and

instructions for manipulating the accessed data.

The instructions for manipulating the data are for example chosen from the group consisting of:

Boolean instructions, such as the OR, XOR, AND, NAND operations, and

arithmetic instructions, such as addition, subtraction, division or multiplication.

By contrast, the source code 62 does not comprise any access instructions for accessing the memory 34, but only access instructions for accessing the main memory 6.

Hereinafter, the description of the compiler 40 is illustrated in the particular case where the source code 62 multiplies two matrices “a” and “b” and saves the result of this multiplication in a matrix “res”. One example of such a source code is given in annex 1 at the end of the description. In these annexes, the numbers on the left and in small characters are line numbers.

In this case, the source code 62 is written in a programming language hereinafter called “V0 language”. The V0 language is identical to the C++ language except that it has additionally been provided with the instructions “MATRIX_DEFINE”, “MATRIX_ALLOCATE”, “MATRIX_FREE”.

The instruction “MATRIX_DEFINE” declares a data structure and, more precisely, a two-dimensional matrix. The instruction “MATRIX_ALLOCATE” dynamically allocates, generally in the heap, the memory space in order to save therein the matrix declared using the instruction “MATRIX_DEFINE” and returns a pointer that points to the start of this matrix. The heap is located in the memory 6. The instruction “MATRIX_FREE” frees up the memory space previously allocated by the instruction “MATRIX_ALLOCATE”. These instructions “MATRIX_DEFINE”, “MATRIX_ALLOCATE”, “MATRIX_FREE” also perform additional functions described in greater detail below.

Thus, in the listing of annex 1, the instruction “MATRIX_DEFINE (TYPE a)” declares a matrix “a”, in which each cell contains a datum having the type “TYPE”. In the source code 62, the type “TYPE” is equal to the type “int” of the C++ language. Each cell of the matrix “a” thus contains an integer.

The instruction “MATRIX_ALLOCATE (TYPE, N0, N1, a)” allocates a memory space large enough to save the matrix “a” of N0 columns and N1 rows there and in which each cell contains a datum of the type “TYPE”.

The instruction “MATRIX_FREE (a, N0, N1, TYPE)” frees up the memory space previously allocated to save the matrix “a” there. Thus, after the execution of this instruction, data other than those of the matrix “a” may be saved in this freed-up memory space.

In addition, the V0 language contains specific instructions for accessing the data of a data structure. In the particular case of the source code 62, since the data structures of the source code 62 are matrices, these specific instructions are denoted “MATRIX_GET”, “MATRIX_SET” and “MATRIX_ADD”.

The instruction “MATRIX_GET (a, k, j)” returns the datum stored in the cell of the matrix “a” located at the intersection of the row “j” and of the column “k”. It is therefore a function for reading a datum from a matrix.

The instruction “MATRIX_SET(res, i, j, d)” saves the value “d” in the cell of the matrix “res” located at the intersection of the row “j” and of the column “i”. It is therefore an instruction for writing a datum to a matrix.

The instruction “MATRIX_ADD(res, i, j, tmp_a*tmp_b)” adds the result of the scalar multiplication of the numbers tmp_a by the number tmp_b to the datum contained in the cell of the matrix “res” located at the intersection of the row “j” and of the column “i”. Once this instruction has been executed, the datum previously contained in the cell of the matrix “res” located at the intersection of the row “j” and of the column “i” is replaced with the result of this addition. This instruction “MATRIX_ADD” is therefore also an instruction to write a datum to a matrix.

The compilation module 64, on the basis of the source code of a computer program, written in V0 language, automatically generates a non-optimized executable code 76. The executable code 76 is able to be executed by the compiler 40. To this end, it uses the set of instructions of the machine language of the microprocessor 56. When compiling the source code, the module 64, for each data structure declared in the source code, implements a predefined standard layout of this data structure in the memory 58. Thus, when the executable code 76 is executed by the microprocessor 56, each data structure is saved in the memory using the same standard layout. In addition, the module 64 does not add any access instruction for accessing the memory 34 to the executable code 76.

For example, if the data structures are matrices, the standard layout of each matrix in the memory 58 is a row layout, as it is known. The row layout is a layout in which the rows of the matrix are saved one after the other in the memory. To do this, each time the module 64 encounters a specific instruction “MATRIX_ALLOCATE”, it replaces it with a set of instructions corresponding to the C++ language that codes this row layout. Hereinafter, this corresponding set of instructions is called the “standard set of instructions” since it codes the standard layout of the data structure.

One example of such a standard set of instructions in C++ language that codes the row layout of the matrix “a” is shown in lines 18 to 20 of the listing of annex 2. Another example of a standard set of instructions for the matrix “res” may be seen in lines 26 to 28 of the listing of annex 2.

The module 64 also replaces each of the other specific instructions of the source code 62 with a corresponding set of instructions in C++ language that codes the corresponding function. For example, in this case, as illustrated by the listing of annex 2:

the specific instruction “MATRIX_DEFINE(TYPE, a)” is replaced with the instruction “int **a” in C++ language,

the instruction “MATRIX_SET(res, i, j, 0)” is replaced with the instruction “res[j][i]=0” in C++ language,

the specific instruction “MATRIX_GET(a, k, j)” is replaced with the instruction “a[j][k]” in C++ language, and

the instruction “MATRIX_ADD(res, i, j, tmp_a*tmp_b)” is replaced with the instruction “res[j][i]+=tmp_a*tmp_b” in C++ language.

After having replaced, in the source code 62, each of the specific instructions with the corresponding standard set of instructions, the module 64 obtains an intermediate source code written entirely in C++ language. The module 64 is capable, for example in a conventional manner, of compiling this intermediate source code in order to obtain the executable code 76.

In this case, the specific instructions that access a datum of a data structure are additionally associated with a set of instructions allowing the retrieving module 68 to be implemented. When replacing each specific instruction that accesses a datum of a data structure with the corresponding set of instructions in C++ language, the module 64 also automatically adds, to the intermediate source code, a set of instrumentation instructions associated with this specific access instruction. Typically, the set of instrumentation instructions is added to the intermediate source code immediately before or after the set of instructions corresponding to this specific access instruction. The set of instrumentation instructions is described in greater detail further on.

The module 66, on the basis of the source code of the computer program written in V0 language, automatically generates an optimized executable code 78 for a computing device comprising a secondary memory, such as the computing device 4.

The executable code 78 is able to be executed by the computing device 4. To this end, it uses the set of instructions of the machine language of the microprocessor of the computing device 4. The executable code 78 is therefore not necessarily able to be executed by the compiler 40 when the set of instructions of the machine language of the computing device 4 is different from that of the microprocessor 56.

In addition, the module 66 replaces each of the specific instructions in V0 language with an optimized coding. An optimized coding is a set of instructions, written in this case in C++ language, that uses the memory 34 to improve the performance of the computing device 4 when it executes the computer program.

In this case, the optimized coding is selected on the basis of the access pattern retrieved by the module 68. On this point, the module 66 functions similarly to what has been described in the case of the compilation module 64, except that the optimized coding that is used is different from the standard set of instructions used by the module 64 to code the same specific instruction.

The module 66 thus automatically transforms the source code 62 into an optimized source code written entirely in C++ language. Next, the module 66 compiles this optimized source code for the target computing device 4. This compilation is for example performed in a conventional manner.

However, in this embodiment, the compilation module 66 does not modify the order, defined by the source code, in which the access instructions are executed. In other words, when the processed data are identical, the order in which the access instructions are executed by the computing device 4 is the same as the order in which these access instructions are executed by the compiler 40 when it executes the executable code 76.

The retrieving module 68 is capable, when the executable code 76 is executed by the compiler 40, and for at least one data structure declared in the source code, of retrieving the access pattern for accessing this data structure.

An access pattern for accessing a data structure is a temporally ordered series of position identifiers of the data of this structure accessed one after the other when the executable code 76 is executed by the microprocessor 56. In this case, the position identifier of a datum is chosen from the group consisting of:

the indices that make it possible to identify the position of the datum within the data structure, and

the virtual address, in the address space of the computer program, of the accessed datum.

The virtual addresses of the data of one and the same data structure are allocated by the instruction “MATRIX_ALLOCATE” such that the data structure is located within a single continuous virtual address range in which there are no data that do not belong to this data structure. The position identifier is therefore in this case either an index or a virtual address.

The indices that make it possible to identify the position of the datum within the data structure are generally used to construct the virtual address of this datum on the basis of a base address of the data structure and of the values of these indices. The base address of the data structure is typically the virtual address at which the memory space in which this data structure is stored begins. In this case, each data structure is located within a single continuous virtual address range of the address space of the computer program. In other words, within this range, there are no data that do not belong to this data structure. In the case of a two-dimensional matrix, the indices correspond to the row and column numbers at the intersection of which the datum to be accessed is located. In this exemplary embodiment, the position identifiers that are used are the row and column numbers of the datum accessed in the matrix.

It is pointed out here that the module 68 retrieves the access pattern for accessing a data structure. Thus, if the source code comprises a plurality of data structures for which the access patterns have to be retrieved, the module 68 retrieves at least one access pattern for each of these data structures. The access pattern for accessing a particular data structure comprises only the position identifiers of the data accessed within this data structure. To distinguish between the various access patterns that the module 68 retrieves, each retrieved access pattern is associated with the identifier of the data structure for which this access pattern has been retrieved.

In this embodiment, the module 68 is implemented by instrumenting the executable code 76. To this end, for example, each specific instruction of the V0 language that is an access instruction for accessing a datum of a data structure is associated with a set of instrumentation instructions. The set of instrumentation instructions is written in C++ language. When it is executed by the microprocessor 56, it makes it possible to retrieve the access pattern for accessing a data structure.

To this end, the instructions “MATRIX_SET”, “MATRIX_GET”, “MATRIX_ADD” are in this case each associated with a set of instrumentation instructions that, when it is executed by the microprocessor 56:

retrieves the identifier of the accessed data structure and the position identifier of the datum accessed within this data structure, and then

adds this retrieved position identifier to the rest of the position identifiers already retrieved for this same data structure in order to supplement the retrieved access pattern for this data structure.

In the case of a two-dimensional matrix, the execution of this set of instrumentation instructions retrieves the identifier of the accessed matrix and the row and column numbers of the datum accessed within this matrix. Next, these retrieved row and column numbers are added, respectively, to first and to second access patterns. The retrieved first and second access patterns contain only the row and column numbers, respectively, of the accessed data.

In addition, in this embodiment, the module 68 retrieves the size of each data structure for which an access pattern is retrieved. To this end, the specific instruction “MATRIX_ALLOCATE” is also associated with a set of instrumentation instructions in C++ language. In the case of the specific instruction “MATRIX_ALLOCATE”, the set of instrumentation instructions, when it is executed, makes it possible to retrieve the size of the data structure and to associate it with the identifier of this data structure. In the case of a matrix, the retrieved size is the number of rows and the number of columns of this matrix. The executable code 76 is thus in this case also instrumented to retrieve the size of each data structure for which an access pattern has to be retrieved.

The module 70 is capable, on the basis of a retrieved access pattern for a data structure, of constructing a signature characteristic of the access operations to this data structure. In this case, the module 70 is capable of constructing a characteristic signature:

that is independent of the number of access operations to the data structure over the course of the same execution of the executable code 76, and

that does not, or practically does not, vary from one execution of the executable code 76 to the next.

To this end, the module 70 transforms the retrieved access pattern into a transformed access pattern. The transformed access pattern is identical to the retrieved access pattern, except that each retrieved position identifier is replaced with a relative position identifier. The relative position identifier of a datum identifies the position of this datum in relation to another datum of the same data structure. To this end, the module 70 applies, to each retrieved position identifier, a transformation function denoted f_{t,m} that transforms this retrieved position identifier into a relative position identifier. To this end, the function f_{t,m}:

computes a first term as a function of the retrieved position identifier to be replaced,

computes a second term as a function of another retrieved position identifier belonging to the same retrieved access pattern, and then

computes the relative position identifier on the basis of the difference between these first and second terms.

The first term is independent of the position identifier used to compute the second term. Reciprocally, the second term is independent of the position identifier to be replaced, used to compute the first term.

There are a very large number of possible functions f_{t,m}. The function f_{t,m} makes it possible to obtain a characteristic signature capable of revealing a particular traversal of the data structure. A traversal of a data structure is the temporal order in which the data of the data structure are accessed, one after the other, when the computer program is executed. A particular traversal is a traversal of a data structure that is associated with an optimized coding of the data structure by the database 74.

In the case of the computing device 4, to speed up the execution of a computer program, it is preferable for the data of the data structure to be saved in the memory 6, as far as possible, in the same order as the order in which the microprocessor 20 accesses these data. Specifically, this improves the locality of the data. The locality of the data is better the higher the probability that data, adjacent to a datum that the microprocessor has just accessed, are accessed in turn in the near future. If the data structure is a matrix, this means for example that, if the computer program accesses the data of this matrix row by row, then the optimized layout of the matrix in the memory 6 is the row layout. Conversely, if the computer program accesses the data of the matrix column by column, then the optimized layout of this matrix in the memory 6 is the column layout.

In this case, the function f_{t,m} is defined by the following relationships: f_{t,m}(xₜ)=(xₜ−xₜ₋₁) and f_{t,m}(yₜ)=(yₜ−yₜ₋₁), where:

f_{t,m}(xₜ) and f_{t,m}(yₜ) are the relative position identifiers, respectively, of the row and of the column of the accessed datum,

xₜ and yₜ are the row and column numbers, respectively, of the datum accessed at the time t, and

xₜ₋₁ and yₜ₋₁ are the row and column numbers, respectively, of the preceding datum accessed in the same matrix at the time t−1.

In the retrieved access pattern, the indices xₜ₋₁ and yₜ₋₁ are the indices that immediately precede the indices xₜ and yₜ.

The module 70 is also capable, for each transformed access pattern, of constructing the normalized statistical distribution of the relative position identifiers contained in this transformed access pattern. A statistical distribution comprises classes of possible values and, associated with each of these classes, a number linked by a usually bijective function to the number of occurrences of this class. In this case, each normalized statistical distribution comprises predefined classes. Each predefined class corresponds to one or more possible values of the relative position identifier. There are enough classes to cover all of the possible values of the relative position identifier. In this case, each class corresponds to a single possible value of the relative position identifier.

The statistical distribution associates, with each class, a quantity that is dependent on the number of times that the value of the relative position identifier corresponding to this class appears in the transformed access pattern. In this case, the statistical distribution is “normalized”, that is to say the sum of the quantities associated with each of the classes of the statistical distribution is equal to one. To this end, the quantity associated with a class is obtained:

by counting the number of occurrences of this class in the transformed access pattern, and then

by dividing this number of occurrences by the total number of relative position identifiers contained in the transformed access pattern.

The combination of the various statistical distributions constructed for the same data structure forms the signature characteristic of the access operations to this data structure.

The module 72 is capable, for each data structure, of constructing a numerical function P_{S}(x) for computing optimized weights w_{S,NbS}(k), in which:

the index “S” is an identifier of the data structure,

NbS is the number of subdivisions of the data structure S, and

k is an order number identifying the subdivision k of the data structure S.

The order number k is an integer that varies from 1 to NbS.

The weight w_{S,NbS}(k) is equal to the size of the data block to be transferred between the memory 6 and the memory 34 in response to the computing device 4 executing an access instruction for accessing a single datum of the subdivision k of the data structure S. Typically, the weight w_{S,NbS}(k) is smaller than the number of data contained in the subdivision k. Specifically, in the case of large matrices, the number of data contained in a subdivision is often too large for them all to be transferred simultaneously to the memory 34.

A subdivision of a data structure is a part of the data structure comprising a plurality of data. The virtual addresses of the data of one and the same subdivision are all consecutive.

In this text, a weight w_{S,NbS}(k) is said to be “optimized” when its value is obtained using following relationship (1): w_{S,NbS}(k)=F(C(D_{k,1}), . . . , C(D_{k,n-1}), C(D_{k,n}), . . . , C(D_{k,Dimk})), where:

F( ) is an increasing function, i.e. a function that increases as soon as any one of the coefficients C(D_{k,n}) increases,

Dimk is the number of data contained in the subdivision k,

“k” is the order number identifying the subdivision k,

“n” is the order number identifying the nth datum D_{k,n} of the subdivision k,

C(D_{k,n}) is a coefficient defined by the following relationship: C(D_{k,n})=Av(D_{k,n})/Occ(D_{k,n}), where:
Av(D_{k,n}) is the average number of access operations to other data of the data structure between two consecutive access operations to the datum D_{k,n} during the execution of the computer program for a size Dim0 of the data structure S,
Occ(D_{k,n}) is the number of times that the datum D_{k,n} has been accessed during the execution of the executable code for the size Dim0 of the data structure S.

It has been observed that, when the weight w_{S,NbS}(k) is computed using relationship (1), then the execution speed of the computer program by the computing device 4 is greatly speed up. Typically, an acceleration by a factor of at least two or ten is obtained starting from the time when the function F( ) is increasing. There are therefore a large number of possible functions F( ). One detailed example of such a function F( ) is described below with reference to the method of FIG. 9.

The database 74 makes it possible to extract one or more model signatures associated with the function f_{t,m}. A model signature is structurally identical to a signature constructed by the module 70. More precisely, a model signature is identical to the signature that is constructed by the module 70 when it uses this given function f_{t,m} and when the microprocessor traverses the data of the data structure by following a particular traversal. For one and the same data structure, the number of possible different particular traversals increases as a function of the number of data contained in this data structure. The number of possible different particular traversals for one and the same data structure is therefore generally very large. Hereinafter, to simplify the description, only a few examples of particular traversals are described in detail. However, the teaching provided in the particular case of these few examples may be applied and transposed to any other possible particular traversal. For example, if the data structure is a matrix, the particular traversals for which it is possible to extract a model signature from the database 74 are in this case:

A traversal P1, i.e. a row-by-row traversal in which the rows of the matrix are accessed one after the other.

A traversal P2, i.e. a column-by-column traversal in which the columns of the matrix are accessed one after the other.

A traversal P3, i.e. a traversal of the main diagonal (or “diagonal major”), in which only the main diagonal of the matrix is accessed.

A traversal P4, i.e. a traversal per row of two-by-two blocks, then per column within each of these blocks.

A traversal P5, i.e. a column-by-column traversal skipping every column whose column number is even.

Examples of traversals P4 and P5 are illustrated, respectively, in FIGS. 3 and 4. In these figures, each number is located within a cell of the matrix. Each number indicates the order number of the order in which this cell is accessed. The cells of these matrices are thus accessed in the order 1, 2, 3, 4 . . . etc. When a cell of the matrix does not comprise an order number, this means that the datum contained in this cell is not accessed in the particular traversal of this matrix. This is notably the case of the particular traversal shown in FIG. 4.

Generally, for one and the same particular traversal of a data structure, the model signature varies according to the size of the data structure. In this case, to avoid saving, in the database 74, for each particular traversal, as many model signatures as there are possible sizes for the data structure, the database 74 associates a parameterized signature model with the function f_{t,m}.

In this case, the parameter of the signature model is the size of the data structure for which a model signature has to be extracted. The parameterized signature model is implemented in this case in the form of a code able to be executed by the microprocessor 56. This parameterized signature model, when it is executed for a particular value of the parameter, generates the model signature corresponding to this particular traversal of a data structure of this size.

Annexes 3 to 6 give the listings, in PYTHON language, of the signature models corresponding to the particular traversals, respectively, P1, P2, P3 and P4.

FIGS. 5 to 8 show the model signatures generated, after normalization, by, respectively:

the signature model of annex 3 for a matrix of ten rows and of ten columns,

the signature model of annex 4 for a matrix of ten rows and of ten columns,

the signature model of annex 5 for a matrix of seven rows and of fourteen columns, and

the signature model of annex 6 for a matrix of twenty rows and of twenty columns.

In this embodiment, for a matrix, a first transformed access pattern is obtained on the basis of the retrieved row numbers and a second transformed access pattern is obtained on the basis of the retrieved column numbers. Thus, in this particular embodiment, the signature characteristic of the access operations to this matrix comprises first and second normalized statistical distributions constructed on the basis, respectively, of the first and second transformed access patterns. Similarly, each model signature therefore comprises first and second statistical distributions. Each of FIGS. 5 to 8 shows, at the top, the first statistical distribution and, at the bottom, the second statistical distribution. In each of FIGS. 5 to 8, the abscissa axis shows the various possible values of the relative position identifier and the ordinate axis shows the quantity associated with each value of the abscissa axis. The numbers indicated next to certain bars of the statistical distributions that are shown correspond to the height of this bar.

As shown by FIGS. 7 and 8, for one and the same particular traversal, the model signature varies according to the size of the matrix.

In the listings of annexes 3 to 6, the following notations are used:

“dimX” is the number of rows of the matrix;

“dimY” is the number of columns of the matrix;

“deltaX” is a table that contains the classes associated with a non-zero quantity in the statistical distribution;

“deltaY” is a table that contains the non-zero quantities associated with a class of the statistical distribution;

“nbBlock_Y_ceil” is equal to the block number in a column of the matrix.

The PYTHON language is a language well known to a person skilled in the art and is well documented. A person skilled in the art is therefore capable of understanding and of implementing the various signature models that are given in annexes 3 to 6 without further explanation. In addition, to simplify these listings, the operation of normalizing each of the statistical distributions of the model signature has not been shown. This normalization operation typically consists in dividing each number of occurrences of each statistical distribution by the total number of data accessed in the particular traversal of the matrix.

The signature models shown in annexes 3 to 6 have been established by comparing, for one and the same particular traversal, various signatures constructed using the function f_{t,m}, for various sizes of the matrix. This comparison makes it possible to identify the one or more quantities of the statistical distribution that vary according to the size of the matrix. For example, in the case of traversal P1, which varies according to the size of the matrix, it is the relative position identifier computed at the time of moving on to the next row. It may easily be seen that, at this particular time, for the index xₜ, the relative position identifier f_{t,1}(xₜ) is equal to 1−dimX. The number of occurrences of row jumps is, for its part, equal to dimY−1.

It may also be seen that, outside of these particular times, the index xₜ is only incremented by 1 at each time t. In this case, the computed relative position identifier f_{t,1}(xₜ) is equal to 1 and the number of occurrences of the value “1” in the transformed access pattern is equal to dimY*(dimX−1).

In the case of more complex traversals, such as traversal P4, the signature model may be constructed by breaking this more complex traversal down in the form of a composition of a plurality of simple particular traversals. For example, traversal P4 may be broken down into:

a row-by-row traversal of the blocks, and

a column-by-column traversal within each block.

The signature model of traversal P4 is therefore established by putting the signature models of traversal P1 together with the signature model of traversal P2. Generating model signatures by combining a plurality of signature models with one another makes it possible, for one and the same number of model signatures capable of being generated, to substantially decrease the number of signature models and therefore to decrease the size of the database 74.

Annexes 3 to 6 are parameterized signature models established for a few examples of particular traversals. However, by applying the same methodology, it is possible to construct a parameterized signature model for any other particular traversal. The methodology described here also makes it possible to establish signature models for all types of data structures, and is not limited to the case of matrices.

The database 74 also associates, with each signature model, the optimized codings of each of the specific instructions of the V0 language that are used to create and then access and free up a data structure. The database 74 thus associates, with each signature model established for a particular traversal, the optimized codings of the instructions of the V0 language corresponding to this particular traversal. Preferably, the database 74 therefore comprises a plurality of, and preferably more than five or ten, signature models, each associated with respective optimized codings of the instructions of the V0 language.

For example, in this embodiment, each signature model is associated, by the base 74, with a conversion table. The conversion table associates, with each specific instruction of the V0 language, a generic optimized coding on the basis of which the module 66 is able to generate the optimized coding specific to a particular data structure of the code 62.

This optimized coding is said to be “generic” because it contains parameters that are replaced with values or names of variables of the source code 62 when the optimized source code is generated by the module 66.

Three examples of conversion tables are given in annexes 7 to 9.

The conversion table of annex 7 contains, in the first column, the specific instruction in V0 language and, in the second column, the generic optimized coding that is associated with this specific instruction. The generic optimized coding is the one used by the module 66 to generate the optimized coding, in C++ language, corresponding to a particular data structure of the source code 62. Each specific instruction contained in the source code 62 contains, for each of the parameters of the generic set associated therewith, a value or the name of a variable. When the module 66 replaces the specific instruction in V0 language with the corresponding optimized coding in C++ language, they replace the parameters of the generic optimized coding, associated with this specific instruction by this conversion table, with the values or the names of variables contained in the specific instruction of the source code 62.

For example, the generic optimized coding associated, by the table of annex 7, with the specific instruction “MATRIX_ALLOCATE” contains four parameters “TYPE”, “NDL”, “NDC”, “NAME”. These parameters “TYPE”, “NDL”, “NDC”, “NAME” correspond, respectively, to the type of data of the matrix, to the number of rows of the matrix, to the number of columns of the matrix and to the name of the matrix.

The generic optimized code comprises a procedure fCut(TYPE, NBL, NBC, NAME) of cutting the data structure. This procedure fcut( ) is written in C++ language. When it is executed, it cuts the matrix into subdivisions and arranges these subdivisions in relation to one another in the main memory 6. Arranging the subdivisions in the memory 6 consists in placing the subdivisions one after the other in the memory 6 in a predetermined order. By way of illustration, the first three lines of the function fCut( ), written in C++ language, illustrates the fact that, in the memory 6, the matrix is saved in the form of a row layout. In the right-hand column of the conversion tables, the symbol “ . . . ” indicates that the representation of some of the instructions in C++ language has been omitted.

In the case of the row layout, typically, a subdivision corresponds to a row of the matrix. The dimension DimS of a subdivision is thus equal to the size of a row. In this first example, the dimension DimS is therefore identical for each of the subdivisions of the matrix.

The dimension DimS depends on the layout selected to save the data structure in the memory 6. Thus, for example, in the case of a column layout such as that of the conversion table of annex 8, a subdivision corresponds to a column of the matrix. In this case, the dimension DimS is equal to the size of a column. In the case of a data block layout such as the one described in the case of traversal P4, a subdivision is a data block traversed in columns. In the latter case, the dimension DimS is equal to the size of one of these blocks traversed in columns. The number NbS of subdivisions and the dimension DimS thus depend on the layout selected to save the data structure and on the size of the data structure. These numbers NbS and DimS are thus known only when the layout for saving a data structure has been selected and when the size of the data structure is known. In other words, the values of these numbers NbS and DimS are in this case determined at the time when the optimized code corresponding to the specific instruction “MATRIX_ALLOCATE” is executed by the computing device 4.

The optimized generic code associated with the instruction MATRIX_ALLOCATE also comprises the generic code of a procedure fTdl(NbS) for computing optimized weights.

The procedure fTdl(NbS) is parameterized by the number NbS of subdivisions of the data structure obtained after execution of the procedure fCut( ).

The main function of this procedure fTdl( ) is that of computing the optimized weight w_{S,NbS}(k) associated with each subdivision k of the data structure S. In this case, this procedure fTdl(NbS) also generates an indirection table Tdl that associates, with each identifier of a subdivision k of the data structure S:

the weight w_{S,NbS}(k) corresponding to this subdivision k,

a “status” field that contains, for each datum contained in the subdivision k, information for ascertaining how to access this datum.

Hereinafter, B_{k,l} denotes the data block that is used to transfer a datum D_{k,n} between the memories 6 and 34. Each block B_{k,l} comprises w_{S,NbS}(k) data. The w_{S,NbS}(k) data of the block B_{k,l} are all located at immediately consecutive addresses in the memory 6. This block B_{k,l} starts with a datum D_{k,l}. The order number “l” indicates the position of this datum D_{k,l} with respect to the start of the subdivision k. In this case, these w_{S,NbS}(k) data are also all located at immediately consecutive addresses in the memory 34 after they are transferred to this memory 34. For example, in this case, each block B_{k,l} is constructed by applying the following construction method. When the datum D_{k,n} is not located on an edge of the subdivision k, then the block B_{k,l} contains the same number of data located before and after the datum D_{k,n}. In other words, the datum D_{k,n} is located in the middle of the block B_{k,l}. When the datum D_{k,n} is located on an edge of the subdivision k, the block B_{k,l} starts or ends on this edge. Thus, by virtue of this construction method, no block B_{k,l} impinges on the subdivisions k−1 and k+1 adjacent to the subdivision k. In this case, the “status” field notably contains the following for each datum D_{k,n} of the subdivision k:

information indicating whether or not this datum D_{k,n} is already present in the memory 34,

information indicating whether this datum D_{k,n} has been modified, in the memory 34, since it was transferred to this memory 34, and

information for discovering the address at which this datum D_{k,n} is saved in the memory 34.

By way of illustration, the information for discovering the address of the datum D_{k,n} in the memory 34 is a table that associates:

the order number “l” of the first datum D_{k,l} of each data block B_{k,l} transferred to the memory 34, and

the virtual address @_{k,l}, in the memory 34, of this datum D_{k,l}.

Thus, when the difference between the order number “n” of the datum D_{k,n} and one of the order numbers “l” is smaller than w_{S,NbS}(k), this means that the datum D_{k,n} belongs to the block starting with the datum D_{k,l}. This information therefore also makes it possible to ascertain whether the datum D_{k,n} is already present in the memory 34. The difference between the order numbers “l” and “n” gives the position of the datum D_{k,n} with respect to the datum D_{k,l}. Therefore, for example, the virtual address @_{k,n} of the datum D_{k,n} in the memory 34 is obtained using the following relationship: @_{k,n}=@_{k,l}+(n−l)O, where O is the size of a datum in bytes.

This procedure fTdl( ) is described in more detail with reference to the method of FIG. 9.

The generic optimized coding associated, by the table of annex 7, with the specific instruction “MATRIX_GET” contains the three parameters “NDL”, “NDC”, “NAME”. The generic optimized code associated with this specific instruction comprises a procedure fGet(NAME, NDL, NDC) of loading a datum of the data structure from the memory. The function fGet( ), when it is executed by the computing device 4, determines the virtual address @_{k,n} of the datum D_{k,n} to be loaded into a register of the microprocessor 20 on the basis of the identifier NAME of the matrix and the row and column numbers NDL, NDC of this datum D_{k,n}. To this end, the procedure fGet( ) identifies the subdivision k of the data structure in which the datum D_{k,n} to be loaded is located on the basis of the row and column numbers NDL, NDC. The procedure fGet( ) also discovers the order number “n” of the datum D_{k,n} in the subdivision k on the basis of these numbers NDL and NDC. It then consults the “status” field associated with this subdivision k by the constructed indirection table Tdl by executing the function fCut( ). If the “status” field indicates that the datum D_{k,n} belongs to a block B_{k,l} that is already in the memory 34, the procedure fGet( ) determines the virtual address @_{k,n} of this datum D_{k,n} in the memory 34 on the basis of the address @_{k,l} at which this block B_{k,l} starts and the order number “n” of the datum D_{k,n}. If the “status” field indicates that the datum D_{k,n} is not in the memory 34 and if the weight w_{S,NbS}(k) is greater than one, then the procedure fGet( ) triggers the execution of a transfer procedure fLoad(NAME, NDL, NDC). In this case, the instructions of the procedure fLoad( ) are integrated within the procedure fGet( ). This is represented in the conversion table of annex 7 by the fact that the procedure fLoad( ) is located between the brackets that follow the declaration of the procedure fGet( ). After it has been executed, the procedure fLoad( ) returns a code that indicates whether, yes or no, a block B_{k,l} containing the datum D_{k,n} has been transferred to the memory 34. If so, the virtual address @_{k,n}, in the memory 34, of the datum D_{k,n} is determined as described above. In other cases, and notably if the code returned by the procedure fLoad( ) indicates that the datum D_{k,n} has not been transferred to the memory 34, then the procedure fGet( ) determines the virtual address @_{k,n} of the datum D_{k,n} in the memory 6. For example, conventionally, the procedure fGet( ) determines the address @_{k,n} of the datum D_{k,n} in the memory 6 on the basis of the starting address of the data structure saved in the memory 6 and the row and column numbers NDL and NDC. Finally, the datum D_{k,n} is loaded into a register of the microprocessor 20 by executing a load instruction parameterized by the determined address @_{k,n}. Thus, if the address @_{k,n} corresponds to an address of the memory 34, the datum D_{k,n} is loaded from the memory 34. Conversely, if the address @_{k,n} corresponds to an address of the memory 6, the datum D_{k,n} is loaded from the memory 6. It is pointed out at this juncture that loading from the memory 6 is performed in a conventional manner, and notably using the cache memory mechanism. Thus, in fact, the expression “load from the memory 6” also covers situations in which the datum D_{k,n} or the data block B_{k,l} is loaded from the cache memory 22 or from the buffer 26. Specifically, the computer program that is executed does not manage access operations to the cache memory 22 and to the buffer 26. As explained above, this is managed by the operating system and the micro-computing device 32 autonomously and independently of the code of the computer program that is executed. Thus, from the viewpoint of the computer program that is executed, the cache memory 22 and the buffer 26 are invisible, and so it knows only the address range of the memory 6. Therefore, even though in reality the datum or the data block is provided from the cache memory 22 or from the buffer 26, the computer program is not aware of this. Thus, from its viewpoint, this datum or this data block is simply loaded from the memory 6.

The procedure fLoad(NAME, NDL, NDC) is a generic code parameterized by the identifier NAME of the data structure and the row and column numbers NDL and NDC of the datum D_{k,n} to be transferred to the memory 34. When it is executed by the computing device 4, this procedure fLoad( ) determines, on the basis of the parameters NAME, NDL and NDC, the identifier k of the subdivision that contains the datum D_{k,n} to be transferred to the memory 34 along with its order number “n” in this subdivision k. Next, on the basis of the identifier k of the subdivision and of the indirection table Tdl created by executing the procedure fCut(, the procedure fLoad( ) selects the weight w_{S,NbS}(k) associated with this subdivision k. Next, a block B_{k,l} of w_{S,NbS}(k) data and containing the datum D_{k,n} is constructed, for example, as described above. After this, the procedure fLoad( ) selects a location in the memory 34 to which this block B_{k,l} may be written. To this end, the procedure fLoad( ) starts by checking whether there is a free location in the memory 34 capable of containing this block B_{k,l}.

If so, this location is selected. If not, the procedure fLoad( ) selects, in the memory 34, the one or more data blocks associated with a weight lower than the weight w_{S,NbS}(k) of the subdivision k to which this block B_{k,l} belongs. Each time the “status” field, associated with one of these selected lower-weight blocks, indicates that at least one of these blocks has been modified in the memory 34 since it was loaded into this memory, then the procedure fLoad( ) copies this modified data block to the memory 6.

Finally, the procedure fLoad( ) transfers the new block B_{k,l} of w_{S,NbS}(k) data from the memory 6 to the selected location in the memory 34. This new transferred block B_{k,l} contains notably the datum D_{k,n}. The address @_{k,l}, in the memory 34, at which the transferred block starts is stored in the “status” field associated with the order number “l” and with the subdivision k of the indirection table Tdl.

If there is no block in the memory 34 that belongs to a subdivision associated with a weight lower than the weight w_{S,NbS}(k), then the block B_{k,l} is not transferred to the memory 34. In this case, the procedure fLoad( ) returns a particular code to the calling procedure that indicates that the datum D_{k,n} has to be accessed from the memory 6 and not from the memory 34.

The generic optimized coding associated, by the table of annex 7, with the specific instruction “MATRIX_SET” contains the four parameters “NDL”, “NDC”, “NAME” and “VALUE”. The parameter “VALUE” is intended to contain the value to be written to the memory 6. The generic optimized code associated with this specific instruction comprises a procedure fSet(NAME, NDL, NDC, VALUE) of writing a datum of the data structure to the memory. The function fSet( ), when it is executed by the computing device 4, determines the virtual address @_{k,n} of the datum D_{k,n} to be written. The address @_{k,n} is an address located in the memory 34 if the datum D_{k,n} is already located in this memory 34. Conversely, the address @_{k,n} is an address located in the memory 6 if the datum D_{k,n} is not already located in the memory 34. For example, the address @_{k,n} is determined in a manner similar to what has been described for the procedure fGet( ). Next, if the “status” field indicates that the data block B_{k,l} containing the datum D_{k,n} to be written is already in the memory 34, then the value VALUE is written, by the microprocessor 20, to the address @_{k,n}, located in the memory 34, by executing a write instruction parameterized by the determined address @_{k,n} and the value VALUE. Next, the “status” field is updated so as to indicate that the datum D_{k,n} has been modified. In this case, executing the function fSet( ) does not trigger any write operation to the memory 6.

Conversely, if the “status” field indicates that the data block B_{k,l} containing the datum D_{k,n} to be written is not in the memory 34, then the value VALUE is written, by the microprocessor 20, to the address @_{k,n}, located in the memory 6, by executing a write instruction parameterized by the determined address @_{k,n} and the value VALUE. In addition, only if the weight w_{S,NbS}(k), associated with the block B_{k,l}, is greater than one, then the procedure fSet(itself also triggers the execution of the procedure fLoad( ) so as to load the datum D_{k,n} into the memory 34. Next, if the datum D_{k,n} has been loaded into the memory 34, the “status” field is updated so as to indicate that the datum D_{k,n} is now present in the memory 34.

The generic optimized coding associated, by the table of annex 7, with the specific instruction “MATRIX_ADD” is derived from the explanations given above.

Typically, the generic optimized coding associated with this specific instruction is a combination of the generic optimized codings associated with the specific instructions “MATRIX_GET” and “MATRIX_SET”.

The generic optimized coding associated, by the table of annex 7, with the specific instruction “MATRIX_FREE” contains the three parameters “NBL”, “NBC”, “NAME”. The generic optimized code associated with this specific instruction comprises a procedure fFree(NAME, NDL, NDC) of freeing up the memory space dynamically allocated to the data structure NAME. The first two lines of the procedure fFree( ) are an illustration of instructions in C++ language that make it possible to free up the memory space allocated for storing the data structure. In addition, the procedure fFree( ) also comprises instructions that erase and free up the memory space in which the table Tdl associated with the data structure was stored.

Annexes 8 and 9 show the conversion tables corresponding to the optimized codings associated, by the database 74, with the signature models, respectively, of annexes 4 and 5. These tables are identical to the table of annex 7, except that the generic optimized coding associated with the specific instruction “MATRIX_ALLOCATE” saves the matrix in the memory:

in the form of a series of columns, and not in the form of a series of rows in annex 8, and

in a form optimized for traversal P3 in annex 9.

The procedures fCut(of annexes 8 and 9 are thus different from the procedure fCut( ) of annex 7. Specifically, the size and the number of subdivisions are not the same as in the case of annex 7. However, aside from this difference, these tables are identical in this case.

The functioning of the compiler 40 will now be described with reference to the method of FIG. 9.

Initially, in a design phase 100, a developer writes, in V0 language, the source code 62 of the computer program. This code is written without specifying the layout of the data structures in memory and without necessarily introducing access instructions for accessing the secondary memory 34 either. For example, in this case, the source code 62 does not contain any access instructions for accessing the memory 34. The writing of this source code is thus conventional except that, for at least one of the data structures of this source code, the developer uses the specific instructions of the V0 language instead of using conventional instructions of the C++ language. For example, in the case of the source code 62 of annex 1, each creation of a matrix and each access operation to the data of the matrices are coded using the specific instructions of the V0 language.

Once the source code 62 has been written, a phase 102 of the source code 62 being compiled by the compiler 40 begins. This phase 102 begins with a step 104 of acquiring the source code 62 and of providing the database 74. On completion of this step, the source code 62 and the database 74 are saved in the memory 58 of the compiler 40.

Next, in a step 106, the compilation module 64 generates the executable code 76 on the basis of the source code 62.

To this end, in an operation 108, the module 64 transforms the source code 62 into an instrumented intermediate source code, written only in C++ language. This transformation consists in replacing each specific instruction of the V0 language of the source code 62 with the concatenation of the corresponding set of instructions in C++ language and of the set of instrumentation instructions associated with this specific instruction. By default, in this first compilation of the source code 62, for each data structure of the source code 62, it is the standard set of instructions that is used. Therefore, in this embodiment, each data structure is saved in the memory, when the executable code is executed, using the standard layout.

On completion of operation 108, the instrumented intermediate source code is written only in C++ language and comprises, for each data structure, the instructions that make it possible to retrieve the identifier of this data structure and the position identifiers of the data accessed within this data structure.

In an operation 110, the intermediate source code obtained on completion of operation 108 is compiled in order to generate the executable code 76.

In a step 112, the microprocessor 56 of the compiler 40 executes the executable code 76.

During this execution, the sizes of the matrices “a”, “b” and “res” are acquired in an operation 114. For example, to this end, the dimensions N0, N1 and N2 are entered by the user using the interface 42 of the compiler 40 when the code 76 is executed. The initial size, acquired in operation 114, for a data structure is hereinafter denoted Dim0.

Next, the microprocessor 56 dynamically allocates, for each data structure, a memory space in the main memory 6 to save the data of this data structure there.

Next, the microprocessor 56 accesses the data of the data structure in the order defined in the source code 62 and therefore according to a traversal coded by the developer of the source code 62. Finally, the microprocessor frees up the dynamically allocated memory space when the data structure is no longer used.

In response to the dynamic allocation of a memory space to save a data structure there, a pointer to the start of this memory space is generated. This pointer is typically equal to a virtual address, called a “virtual base address” here, at which this memory space begins. In this case, this pointer constitutes the identifier of the data structure or is associated with the identifier of the data structure.

In each access operation to a datum of the data structure, the microprocessor 56 starts by constructing the virtual address of this datum on the basis of the base address and of the values of the indices that identify the position of this datum within the data structure.

Next, it executes the access instruction for accessing this datum. This access instruction may be an instruction to write or to read the datum. This access instruction contains an operand from which the virtual address of the accessed datum is obtained. These instructions correspond here to the instructions coded in lines 33 and 36 to 38 of the listing of annex 1.

Between two access operations to the data of the data structure, the microprocessor 56 executes an instruction that modifies the one or more indices such that, when the next access instruction is executed, it is the following datum of the data structure that is accessed. In the listing of annex 1, this corresponds to the incrementation of the indices j, i and k that may be seen in lines 29, 31 and 34, respectively, of this listing.

During this execution of the executable code 76, the microprocessor 56 also executes the instructions corresponding to the sets of instrumentation instructions introduced into the intermediate source code by the compilation module 64. Thus, in step 112, the module 68 for retrieving the access patterns is also executed by the microprocessor 56 at the same time as the executable code 76.

Then, in an operation 118, each time the microprocessor 56 accesses a datum of a data structure, the module 68 retrieves:

the identifier of this data structure, and

the position identifiers of the datum accessed within this data structure.

In this embodiment, the identifiers of the position of the datum correspond, respectively, to the number of the row xₜ and to the number of the column yₜ at the intersection of which the accessed datum is located. In the listing of annex 1, this therefore corresponds to the values of two of the indices chosen from among the indices i, j and k that are used, in the source code, to denote the row and column numbers.

Next, the module 68 adds the retrieved values of the indices to the access pattern constructed specifically for this data structure. Thus, for example, each time the matrix “a” of the source code 62 is accessed, the module 68 retrieves the values of the indices x_{a,t}, y_{a,t} of the datum accessed in this matrix. In this case, the indices x_{a,t}and y_{a,t} correspond, respectively, to the values of the indices k and j of line 36 of the listing of annex 1. Next, the module 68 adds the new retrieved value to an access pattern MAₓₐ specifically associated with the matrix “a” and containing the preceding values retrieved for the index x_{a,t}. The access pattern MAₓₐ thus takes the form of a series {x_{a,1}; x_{a,2}; . . . ; x_{a,t}} of row numbers classed in the order of the times at which these numbers were retrieved.

In parallel, the module 68 adds the new retrieved value to a second access pattern MA_{ya} specifically associated with the matrix “a” and containing the preceding values retrieved for the index y_{a,t}. This access pattern MA_{ya} thus takes the form of a series {y_{a,1}; y_{a,2}; . . . ; y_{a,t}} of column numbers classed in the order of the times at which these numbers were retrieved.

In addition, in this embodiment, each time a memory space is dynamically allocated to save a data structure there, the module 68 retrieves the size of this memory space. In this case, if the data structures are two-dimensional matrices, the module 68 retrieves the number of rows dimX and the number of columns dimY and associates them with the identifier of this matrix. This information is for example saved in the memory 58.

Next, in a step 120 and after the end of the execution of the code 76, the module 70 constructs, for each data structure, the signature characteristic of the access operations to this data structure.

In an operation 126, the module 70 then transforms each of the access patterns retrieved for a data structure into a transformed access pattern by applying the selected function f_{t,m}. Thus, in the case of the matrix “a”, the access patterns MAₓₐ and MA_{ya} are transformed into transformed access patterns MATₓₐ and MAT_{ya}, respectively.

The access pattern MATₓₐ is equal to the series of relative position identifiers {f_{t,m}(x₂); f_{t,m}(x₃); . . . ; f_{t,m}(x_{a,n})}, i.e. equal to the series {x_{a,2}-x_{a,1}; x_{a,3}-x_{a,2}; . . . ; x_{a,n}-x_{a, n-1}}, where n is equal to the total number of elements of the access pattern MAₓₐ. Similarly, the pattern MAT_{ya} is equal to the series {f_{t,m}(y_{a,2}); f_{t,m}(y_{a,3}); . . . ; f_{t,m}(y_{a,n})}, i.e. equal to the series {y_{a,2}-y_{a,1}; y_{a,3}-y_{a,2}; . . . ; y_{a,n}-y_{a, n-1}}.

Next, in an operation 128, the module 70 constructs the normalized statistical distributions DSₓₐ and DS_{ya} of the values, respectively, of the access patterns MATₓ and MAT_{ya}.

The normalization of the constructed statistical distribution consists here in dividing the number of occurrences of each class in the transformed access pattern by the number n-1 of elements of this transformed access pattern.

The combination of the statistical distributions DSₓₐ and DS_{ya} constitutes the characteristic signature constructed for the access operations to the matrix “a” when the executable code 76 is executed by the microprocessor 56.

Operations 126 to 128 are reiterated for each of the data structures for which the module 68 has retrieved access patterns in step 112.

Once the characteristic signature has been constructed for each of the accessed data structures, the compiler 40 moves on to a step 140 of automatically optimizing the computer program for the computing device 4. To this end, it proceeds as follows for each data structure.

In an operation 142, the compilation module 66 extracts, from the database 74, the various model signatures that may correspond to the signature constructed for this data structure. In this case, to this end, it selects, from the database 74, the signature models constructed using the function f_{t,m}.

Then, using each selected signature model and by replacing, in this signature model, the variables dimX and dimY with the values retrieved in operation 118, the compiler 40 constructs the model signature of a particular traversal of the data within a matrix of the same size.

When the selected signature model comprises a variable whose value is not known, then the compilation module 66 executes this signature model for each of the possible values of this variable. Thus, in this case, on the basis of one and the same signature model and for the same size of the data structure, a plurality of model signatures are generated. This is for example the case when the signature model of annex 6 is selected. Specifically, this signature model comprises the variable “nbBlock_Y_ceil” whose value is not retrieved by the module 68. The possible values of the variable “nbBlock_Y_ceil” are the integers between 1 and dimY.

In an operation 144, the compilation module 66 compares the constructed signature with each model signature extracted from the database 74 in operation 142.

In this case, to make this comparison between the constructed signature and the model signature, the module 66 computes a coefficient of correlation between each statistical distribution of the constructed signature and the corresponding statistical distribution of the model signature. In this embodiment, this coefficient of correlation is an adaptation of the coefficient known as the “Pearson coefficient”. This coefficient is defined by following relationship (2):

$$ρ ( {DS}_{c} , {DS}_{m} ) = \frac{1}{N} \frac{{\sum }_{i = 0}^{N - 1} ( {DS}_{c} [ i ] - {E}_{DSc} ) ( {DS}_{m} [ i ] - {E}_{DSm} )}{{σ}_{s} {σ}_{{s}^{′}}}$$

where:

ρ(DS_{c}, DSₘ) is the coefficient of correlation,

DS_{c} and DSₘ are, respectively, the compared constructed statistical distribution and model statistical distribution,

N is the total number of classes of the compared statistical distribution,

DS_{c}[i] is the quantity associated with the i^{th} class by the statistical distribution DS_{c},

DSₘ[i] is the quantity associated with the i^{th} class by the statistical distribution DSₘ,

E_{DSc} and E_{DSm} are the expected values, respectively, of the statistical distributions DS_{c} and DSₘ,

σ_{DSc} and σ_{DSm} are the standard deviations, respectively, of the statistical distributions DS_{c} and DSₘ.

Next, the coefficient of correlation between the constructed signature and a model signature is taken to be equal to the average of the coefficients of correlation that are computed for each of the statistical distributions of the constructed signature.

FIG. 10 shows, on the left, the two statistical distributions DSₓₐ and DS_{ya} constructed for the matrix “a” in step 120 in the case where the size of the matrix “a” is ten rows and ten columns.

FIG. 10 shows, on the right, the two statistical distributions of the model signature extracted from the database 74 that have the highest coefficient of correlation with the constructed signature. In this case, this is the model signature generated by the signature model of annex 3, i.e. the one corresponding to traversal P1. FIG. 10 also shows, on the left, the two statistical distributions of the characteristic signature constructed for the matrix “a” when it comprises ten rows and ten columns. The numerical value above the arrow that points from the constructed signature to the model signature is the value of the computed coefficient of correlation between the constructed signature and the model signature.

FIGS. 11 and 12 are identical to FIG. 10, except that the matrix “a” is replaced with, respectively, the matrices “b” and “res” of the source code 62. In this case, the matrices “b” and “res” are matrices of ten rows and ten columns.

FIG. 11 shows that the signature characteristic of the access operations to the matrix “b” exhibits a very high correlation with the model signature generated on the basis of the signature model of annex 4, i.e. the one corresponding to the particular traversal P2 of a matrix.

FIG. 12 shows that the model signature that is most highly correlated with the signature constructed for the matrix “res” is again the one generated on the basis of the signature model of annex 3.

At the end of operation 144, for each data structure, the module 66 identifies the model signature that corresponds best to the characteristic signature constructed for this data structure. To this end, the module 66 retains the model signature that exhibits the highest coefficient of correlation with the signature constructed for this data structure. Hereinafter, the model signature thus identified is referred to as the model signature “corresponding to the constructed characteristic signature”.

In an operation 146, for each data structure, the module 66 automatically selects the generic optimized coding that is associated, by the database 74, with the signature model used to generate the model signature corresponding to the constructed characteristic signature. Thus, in view of the results illustrated in FIGS. 10 to 12, the module 66 selects the optimized codings of annex 7 for the matrices “a” and “res” and the optimized codings of annex 8 for the matrix “b”.

The optimized coding selected for the instruction “MALLOC_ALLOCATE” defines the optimized layout in which the data structure should be saved in the memory 6. This optimized coding also defines the number NbS of subdivisions of the data structure for each possible size of this data structure.

Hereinafter, the number NbS0 denotes the number of subdivisions of the data structure as determined by applying the function fCut( ), defined in the selected optimized coding of the instruction “MALLOC_ALLOCATE”, and when the size of this data structure is equal to the size Dim0 acquired in operation 114.

Next, in an operation 148, for each data structure, the module 72 constructs a respective indirection table Tdl0 that associates an optimized weight w_{S,NbS0}(k) with each of the NbS0 subdivisions.

In this embodiment, the weight w_{S,NbS0}(k) is computed on the basis of the access pattern retrieved in operation 118 for this data structure. To this end, the module 72 begins by determining the number NbS0 of subdivisions of the matrix using the function fCut( ) contained in the optimized coding of the instruction “MATRIX_ALLOCATE” selected in operation 146.

Next, the module 72 computes NbS0 optimized weights w_{S,NbS0}(k) for this data structure of size Dim0. To this end, each weight w_{S,NbS0}(k) is determined by implementing relationship (1) presented above. In this case, the function F( ) of relationship (1) is implemented in the form of a three-step weight assignment procedure:

Step 148.1): Computing a coefficient C(D_{k,n}) for each datum D_{k,n} of the data structure S,

Step 148.2): Computing an intermediate weight wi_{S,NbS0}(D_{k,n}) for each datum D_{k,n} of the data structure S,

Step 148.3): Computing the weight w_{S,NbS0}(k) for each subdivision k of the data structure S.

In step 148.1, the module 72 computes, for each datum D_{k,n}, a coefficient C(D_{k,n}) representative of the benefit of storing this datum D_{k,n} in the memory 34. In this case, the greater the value of the coefficient C(D_{k,n}), the greater the expected gain in execution speed of the computer program by placing the datum D_{k,n} in the memory 34. To this end, in this embodiment, the value of the coefficient C(D_{k,n}) increases as a function of a quantity Av(D_{k,n}) and decreases as a function of a quantity Occ(D_{k,n}). The quantities Av(D_{k,n}) and Occ(D_{k,n}), defined above, are computed on the basis of the access pattern retrieved in operation 118 for this data structure.

To this end, in this case, the module 72 starts by combining the two access patterns retrieved for each index of the data structure so as to form just one complete access pattern comprising, for each accessed datum, its complete position identifier. For example, in the case of the matrix “a”, the module 72 combines the access patterns MAₓₐ and MA_{ya} to obtain the complete access pattern {(x_{a,1}, y_{a,1}); (x_{a,2}, y_{a,2}); . . . ; (x_{a,t-1}, y_{a,t-1}); (x_{a,t}, y_{a,t}); . . . ; (x_{a,max}, y_{a,max})}, where (x_{a,t}, y_{a,t}) is the identifier of the position of the datum of the matrix “a” accessed at the time t.

Next, to compute the quantity Occ(D_{k,n}), the module 72 counts the number of times that the position identifier, corresponding to the datum D_{k,n}, occurs in the retrieved complete access pattern. This number is equal to the value of the quantity Occ(D_{k,n}), i.e. to the number of times that the datum D_{k,n} has been accessed during the execution of the code 76, and when the dimension acquired for this data structure is equal to Dim0.

The module 72 also counts in the retrieved complete access pattern, between each pair “i” of consecutive position identifiers of the datum D_{k,n}, the number Naᵢ of position identifiers that are different from the one corresponding to the datum D_{k,n}. This number Naᵢ is therefore equal to the number of data, other than the datum D_{k,n}, accessed between two consecutive access operations to the datum D_{k,n}. The total of these numbers Naᵢ divided by the number of intervals between the identifiers of the position of the datum D_{k,n} gives the value of the physical quantity Av(D_{k,n}). This number of intervals between two data D_{k,n} accessed consecutively is equal to Occ(D_{k,n})−1.

In this case, the coefficient C(D_{k,n}) is defined by the following relationship: C(D_{k,n})=Av(D_{k,n})/Occ(D_{k,n}). When the quantity Occ(D_{k,n}) is zero or equal to one, the coefficient C(D_{k,n}) is equal to zero.

Preferably, to speed up the computation of the coefficient C(D_{k,n}), this is computed using the following relationship:

$$C ( {D}_{i} ) = \frac{1}{{\sum }_{j = 0}^{N - 1} {s}_{i} ( j )} \times \frac{{\sum }_{j = 0}^{Occ ( i )} {\sum }_{k = 0}^{N - 1} Dirac ( {\sum }_{i = 0}^{N - 1} {s}_{i} ( l ) - j )}{{\sum }_{j = 0}^{N - 1} {s}_{i} ( j ) - 1}$$

where:

Dᵢ is the datum located at the address @ᵢ in the data structure S,

Occ(i) is the number of access operations to the address @ᵢ and therefore to the datum Dᵢ,

N is the total number of access operations to the data structure S,

sᵢ( ) is a similarity function such that sᵢ(j)=1 if the ith address accessed is the same as the jth address accessed in the retrieved access pattern,

Dirac( ) is the discrete Dirac function.

More precisely, the similarity function sᵢ( ) is defined by the following relationship:

$$∀ i ∈ [ 0 , N - 1 ] , {s}_{i} : \{ \begin{matrix}[ [ 0 , N - 1 ] ] \to \{ 0 , 1 \} \\ j \to \{ \begin{matrix}1 if {@}_{i} = {@}_{j} \\ 0 otherwise\end{matrix} \}\end{matrix} \}$$

where:

@ᵢ and @ⱼ are, respectively, the ith address and the jth address accessed,

the term “if” corresponds to its conventional meaning,

the term “otherwise” corresponds to its conventional meaning.

The function Dirac( ) is defined by the following relationship:

$$\{ \begin{matrix}ℤ \to \{ 0 , 1 \} \\ j \to \{ \begin{matrix}1 if j = 0 \\ 0 ohterwise\end{matrix} \}\end{matrix} \}$$

where the terms “if” and “otherwise” have the same meaning as in the above relationship.

Next, in step 148.2, the module 72 assigns, to each datum D_{k,n}, an intermediate weight wi_{S,NdS0}(D_{k,n}) whose value is greater the greater the coefficient C(D_{k,n}).

In addition, in this case, the value of each intermediate weight wi_{S,NdS0}(D_{k,n}) is chosen as being an integer multiple of a parameter So. The parameter So is chosen so as to optimize and speed up the transfer of data between the memories 6 and 34. For example, since the bus 28 makes it possible to simultaneously transfer four data between the memories 6 and 34, the parameter So is taken to be equal to four, i.e. equal to the number of data able to be transferred simultaneously between the memories 6 and 34. To this end, the values of each intermediate weight wi_{S,NdS0}(D_{k,n}) are all chosen from a group G_{w} consisting of values {0; So; 2So; . . . ; (w−1)So; wSo; . . . ; wₘₓSo}, where w is an integer varying from 0 to wₘₐₓ. In this case, wₘₐₓ is chosen to be equal to the integer part of the ratio M/(μSo), where:

M is the maximum number of data able to be saved simultaneously in the memory 34, and

μ is a number greater than one and, typically, greater than or equal to two, five or ten.

The value wₘₐₓSo is thus systematically smaller than the size of the memory 34 and typically at least twice as small as the size of the memory 34 expressed as a number of data able to be saved simultaneously in this memory 34.

To arrive at this, in this case, the module 72 groups the data D_{k,n} in classes of coefficients C(D_{k,n}). Each class groups together the data D_{k,n} associated with coefficients C(D_{k,n}) that are close to one another. The coefficients C(D_{k,n}) of the data D_{k,n} that belong to one and the same class are thus closer to the median value of the coefficients C(D_{k,n}) of this class than the median values of the other classes. To this end, in this case, the average distance between the coefficients C(D_{k,n}) of a first class and the coefficients C(D_{k,n}) of the immediately adjacent classes is greater than the standard deviation of the coefficients C(D_{k,n}) grouped into this first class. Preferably, the grouping algorithm implemented in order to group the data D_{k,n} of the data structure into various classes as a function of the value of their coefficients C(D_{k,n}) is the algorithm known by the acronym AMSC (“Agglomerative Mean-Shift Clustering”). This AMSC algorithm is described for example in the following article: Xiao-Tong Yuan, Bao-Gang Hu, and Ran He.: “Agglomerative mean-shift clustering”, IEEE Transactions on Knowledge and Data Engineering 24, 2 (2010), 209-219.

This AMSC algorithm exhibits multiple advantages. The number of classes to be used is determined by the algorithm itself and not set in advance. This avoids having to arbitrarily set the number of classes to be used. Only the maximum number of classes is set in advance. In addition, this AMSC algorithm may be parameterized so as to set the maximum number of data D_{k,n} able to be grouped into one and the same class. By virtue of this, the use of the memory 34 is reserved for data D_{k,n} that will make it possible to achieve a substantial improvement in the execution speed of the computer program by the computing device 4.

Next, the classes are ordered in increasing order of their median value of the coefficients C(D_{k,n}) that they group together.

The module 72 then assigns the smallest value of the group G_{w} to the data contained in the first class, and then assigns the smallest remaining value contained in the group G_{w} to the data D_{k,n} of the second class, and so on until the last class.

The functioning of step 148.2 is illustrated schematically in the graph of FIG. 13 for the data D_{k,n} associated with a non-zero coefficient C(D_{k,n}). The data D_{k,n} whose coefficient C(D_{k,n}) is zero are systematically associated with a zero intermediate weight. On this graph, the abscissa axis shows the position identifier of each datum D_{k,n}. In this case, the position identifier is the row number and the column number between brackets of each datum D_{k,n}. The ordinate axis shows the value of the coefficient C(D_{k,n}) computed for each datum D_{k,n}. On this graph, the data are ordered in increasing order of coefficient C(D_{k,n}). The horizontal arrows point to the value of the group G, with which the datum D_{k,n} has been associated. Thus, a plurality of data D_{k,n} associated, by a horizontal arrow, with the same value of the intermediate weight wi_{S,NdS0}(k) belong to the same class. For example, in FIG. 13, the data D_{k,n} of coordinates [0; 1] and [3; 3] belong to the same class and are both associated with the same value So of the intermediate weight.

Finally, in step 148.3, for each subdivision k of the data structure, the module 72 computes the weight w_{S,NbS0}(k) associated with this subdivision k. To this end, for example, the module 72 first computes an average intermediate weight for the subdivision k by computing the arithmetic mean of the intermediate weights wi_{S,NbS0}(D_{k,n}) of each of the data D_{k,n} belonging to this subdivision k. The weight w_{S,NbS0}(k) associated with the subdivision k is then taken to be equal to the value contained in the group G_{w} that is closest to this average intermediate weight. The value of each of the weights w_{S,NbS0}(k) thus itself also belongs to the group G_{w}.

On completion of step 148.3, the module 72 has therefore computed an optimized weight w_{S,NbS0}(k) for each of the NbS0 subdivisions of the data structure. The value of this weight w_{S,NbS0}(k) depends on the order number k.

In the indirection table Tdl0, this weight w_{S,NbS0}(k) is associated with the contiguous virtual address range corresponding to the subdivision k.

If, during a subsequent execution of the computer program, the size acquired for the data structure is different from that acquired in step 114, the number of subdivisions of the data structure is generally different from NbS0. Hereinafter, this different number of subdivisions is denoted “NbS1” and corresponds to a size Dim1 of the data structure. The size Dim1 is different from the size Dim0. It is therefore necessary to assign an optimized weight w_{S,NbS1}(k) to each of these NbS1 subdivisions, where k this time varies from 1 to NbS1.

To speed up the subsequent executions of the computer program with different sizes for the data structure, a method is implemented here that is faster than the one consisting in again executing:

step 112, this time choosing the size Dim1 for the data structure, and then

step 148, using the retrieved access pattern in the new execution of step 112.

To this end, in an operation 150, the module 72 constructs a numerical function P_{S}(x) that makes it possible to compute the optimized weights for an arbitrary number of subdivisions of the data structure S. The function P_{S}(x) is continuous over the interval [1; NbS0] and passes through each of the points of coordinates [k; w_{S,NbS0}(k)], where w_{S,NbS0}(k) is the weight determined in step 148. It is pointed out that, when k denotes a subdivision of the data structure of size Dim0, k is an integer that varies between 1 and NbS0. When k denotes a subdivision of the data structure of size Dim1, k is an integer that varies between 1 and NbS1. In this text, each time the index k is used, based on the context, it is easy to ascertain whether the index k denotes a subdivision of a data structure of size Dim0 or Dim1 or something else. Thus, hereinafter, the same notation “k” is used to denote the identifier of a subdivision of a data structure of any size.

In this case, the function P_{S}(x) is defined over each interval [k; k+1] by a third-order polynomial denoted P_{S,k}(x). There are thus 4(NbS0-1) variables to be determined in order to construct the function P_{S}(x) that is continuous over the interval [1; NbS0]. To obtain enough equations to compute the values of these variables, the following conditions are imposed:

Condition (1): at each point [k; w_{S,NbS0}(k)], the following relationships are satisfied:

P_{S,k}(k)=w_{S,NbS0}(k) and P_{S,k}(k+1)=w_{S,NbS0}(k+1).

Condition (2): for values of k between 2 and NbS0−1, at each point [k; w_{S,NbS0}(k)], the following relationship is satisfied: d(P_{S,k-1}(k)/dx=d(P_{S,k}(k)/dx, where the symbol “d/dx” denotes the first derivative with respect to the variable x. In other words, the first derivatives of the polynomials P_{S,k-1}(x) and P_{S,k}(x) are equal at these points [k; w_{S,NbS0}(k)].

Condition (3): for values of k between 2 and NbS0−1, at each point [k; w_{S,NbS0}(k)], the following relationship is satisfied: d²P_{S,k-1}(k)/dx²=d²P_{S,k}(k)/dx², where the symbol “d²/dx²” denotes the second derivative with respect to the variable x. In other words, the second derivatives of the polynomials P_{S,k-1}(x) and P_{S},k(x) are equal at these points [k; w_{S,NbS0}(k)].

Condition (4): for values of k between 2 and NbS0−1, when the point [k; w_{S,NbS0}(k)] is a local extremum, the following relationship is satisfied: d(P_{S,k-1}(k))/dx=d(P_{S,k}(k))/dx=0. In other words, the first derivatives of the polynomials P_{S,k-1}(x) and P_{S,k}(x) are zero at the point [k; w_{S,NbS0}(k)]. The point [k; w_{S,NbS0}(k)] is a local extremum if it satisfies one of the following two conditions:

w_{S,NbS0}(k)>w_{S,NbS0}(k−1) and w_{S,NbS0}(k)>w_{S,NbS0}(k+1), or

w_{S,NbS0}(k)<w_{S,NbS0}(k−1) and w_{S,NbS0}(k)<w_{S,NbS0}(k+1).

Conditions (1) to (3) form 4NbS0−6 equations.

Condition (4) is substituted for condition (2) when the point [k; w_{S,NbS0}(k)] is a local extremum. Condition (4) thus makes it possible to introduce two equations into the system of equations to be solved rather than just one when the point is not a local extremum. Condition (4) therefore makes it possible to obtain between 0 and (NbS0−2)/2 additional equations. If condition (4) provides more than two additional equations, then only two of these additional equations are selected so as to obtain a total number of equations equal to 4NbS0-4. For example, to this end, each possible pair of additional equations is tested in order to select the one that gives the best result. In other words, for each pair of additional equations, the function P_{S}(x) is constructed, and then the rest of the method is executed until obtaining an optimized executable code 78. The performance of the computing device 4 is then measured when it executes this executable code. The pair of additional equations that are selected is the one that makes it possible to obtain the best performance, that is to say the fastest execution speed.

Conversely, if the number of additional equations introduced by condition (4) is insufficient, then additional conditions are placed on the extremities of the function P_{S}(x). For example, one or both of the following additional conditions are used:

Condition (5): at the point [1; w_{S,NbS0}(1)], the following relationship is satisfied: d²P_{S,NbS0}(1)/dx²=0. In other words, the second derivative of the function P_{S}(x) is zero for x=1.

Condition (6): at the point [NbS0; w_{S,NbS0}(NbS0)], the following relationship is satisfied: d²P_{S,NbS0}(NbS0)/dx²=0. In other words, the second derivative of the function P_{S}(x) is zero for x=NbS0.

Thus, with the above conditions, regardless of the situation, the module 72 is able at least to obtain as many equations as there are variables to be determined.

The module 72 solves the system of equations obtained on the basis of conditions (1) to (6). On completion of operation 150, the equations of the NbS0−1 polynomials P_{S,k}(x), thus determined, form the function P_{S}(x) that is continuous over the interval [1; NbS0]. For each integer value of the variable x, that is to say when the variable x is equal to k, the function P_{S}(x) returns the value that is equal to the weight w_{S,NbS0}(k) associated with the subdivision k when the size of the data structure is equal to Dim0.

In operation 152, the module 72 constructs the procedure fTdl(NbS) that receives, at input, the number NbS of subdivisions and that provides, at output, for each of these NbS subdivisions, the value of the weight w_{S,NbS}(k) associated with this subdivision. In this case, the procedure fTdl( ) for this purpose generates an indirection table Tdl, at output, when it is executed by the computing device 4. The table Tdl associates the optimized weight w_{S,NbS}(k) of the subdivision k with each subdivision k of the data structure. In addition, in this case, the generated indirection table also associates, with each of the subdivisions k, its own “status” field that makes it possible to determine how the data D_{k,n} of this subdivision k are accessed and transferred to the memory 34.

In this case, the procedure fTdl(NbS) computes each optimized weight w_{S,NbS}(k) for each of the NbS subdivisions of the data structure S using the following relationship: w_{S,NbS}(k)=P_{S}(1+(k−1)(NbS0−1)/(NbS−1)), where k is the order number of the subdivision and in this case varies from 1 to NbS and the function P_{S}( ) is the function constructed in operation 150.

In other words, the optimized weight w_{S,NbS}(k) is computed through interpolation on the basis of the weights w_{S,NbS0}(k), and not by again executing step 112 and operation 148 for the number NbS of subdivisions of the data structure S.

This is illustrated schematically in FIG. 14. The graph at the top shows a highly simplified example of the function P_{S}(x) constructed in operation 150 and in the particular case in which the number NbS0 is equal to six. The abscissa axis shows the value of the index k identifying the subdivision. The ordinate axis shows the value of the weight w_{S,NbS0}(k) associated with each index k.

The graph at the bottom is identical to the graph at the top, except that it shows the weights w_{S,NbS}(k), computed using the function P_{S}(x), in the case in which the number NbS of subdivisions is equal to eleven. As revealed by comparing the graphs at the top and the bottom of FIG. 14, the procedure fTdl( ) stretches the curve of the graph at the top, defined only over the interval [1; NbS0], so as to obtain a curve that is identical but that extends over the interval [1; NbS].

The constructed procedure fTdl( ), when it is executed by the computing device 4, generates the indirection table Tdl. When this indirection table is created, the information contained in the “status” field is initialized to indicate that:

none of the data D_{k,n} of the data structure S have been modified, and

none of the data D_{k,n} of the data structure S are present in the memory 34 at this stage.

The code, in this case in C++ language, of the procedure fTdl( ) is then integrated into the optimized coding of the instruction “MATRIX_ALLOCATE” shown in annex 7.

Thus, each time a memory space is dynamically allocated for a new data structure S, the optimized layout of this data structure is used and defined by the procedure fCut( ) and the interaction table Tdl corresponding to the size of this data structure is generated dynamically.

Finally, in an operation 154, the module 66 replaces each specific instruction that manipulates a particular data structure in the source code 62 with the corresponding optimized coding in C++ language. The corresponding optimized coding is generated on the basis of the generic optimized coding associated with this specific instruction by the conversion table selected for this data structure in operation 146. More precisely, the corresponding optimized coding in C++ language is obtained by replacing the various parameters of the generic optimized coding with the values of the parameters of the specific instruction.

For example, the specific instruction “MATRIX_ALLOCATE (TYPE, N0, N1, a)” of line 17 of the source code 62 comprises the following values “TYPE”, “NO”, “N1” and “a” of the parameters “TYPE”, “NBL”, “NBC”, “NAME” of the generic optimized coding associated with this specific instruction by the conversion table of annex 7. Therefore, after replacing the parameters of the generic optimized coding with these values, the module 66 obtains the corresponding optimized coding in C++ language. By doing likewise for the specific instruction of line 21 of the source code 62 and this time using the conversion table of annex 8, the module 66 obtains corresponding optimized coding in C++ language.

Thus, at the end of operation 154, the module 66 obtains an optimized source code in which the coding of the data structures is optimized for using the memory 34.

Next, in a step 160, the module 66 compiles this optimized source code for the target computing device 4. This step is for example performed in a conventional manner. On completion of step 160, the optimized executable code 78 has been generated.

In a step 162, the executable code 78 is provided and loaded into the memory 8 of the computing unit 2 and becomes the executable code 12, executed by the computing device 4.

In a step 164, the computing device 4 executes the executable code 12 generated by the compiler 40.

When the code 78 is executed, the computing device 4 executes notably the following operations for each of the data structures, the sizes of which are defined dynamically during the execution of the code 78. Hereinafter, these operations are described in the particular case of matrix “a”. However, everything that is described in this particular case is easily transposed to the cases of the other matrices “b” and “res”.

In an operation 170, the computing device 4 acquires the size of the matrix “a”.

Next, in an operation 172, the computing device dynamically allocates a space, in the memory 6, to store the matrix “a” there. In this operation, the computing device executes the procedure fCut(INT, N0, N1, “a”). Thus, in this operation, the computing device 4 divides the address range, allocated to storing the matrix “a” in the memory 6, into NbS1 subdivisions and arranges these subdivisions in relation to one another within this address range. On completion of the execution of the procedure fCut( ), the number NbSa of subdivisions of the matrix “a” is therefore known.

Next, in an operation 174, the computing device executes the procedure fTdl(NbSa). On completion of the execution of the procedure fTdl(NbSa), the indirection table Tdla, which associates the weight w_{a,NbSa}(k) and the “status” field with each subdivision k, is created and initialized.

Next, the access operations for accessing the matrix “a” are executed. In this particular case, this involves only an operation of reading the data from the matrix “a”. Thus, in this particular case, in an operation 176, each time a datum a[k,j] located at the intersection of the column k and of the row j of the matrix “a” has to be read, the function fGet(“a”, k, j) is executed. If the datum a[k,j] is contained in a subdivision k whose weight w_{a,NbSa}(k) is greater than one and that is not already in the memory 34, this causes the execution of the procedure fLoad(“a”, k, j). The datum a[k,j] is therefore transferred to the memory 34 and then read from the memory 34. Next, in the following executions of the procedure fGet(“a”, k, j), the datum a[k,j] is read directly from the memory 34.

Various tests were performed to verify that the executable code 78 generated by the compiler 40 did indeed allow the performance of the computing device 4 to be improved when it executes this executable code 78. It was observed that the code 78 runs at least twice as fast, and more often ten times or fifty times faster, than a computer program that is identical but that does not use the memory 34. In addition, it was able to be observed that the performance of the computing device 4 practically does not vary when the sizes of the matrices “a”, “b” and “res” are modified upon each execution of the code 78. For example, it was observed that the ratio, equal to the execution time of the code 78 by the computing device 4 divided by the sizes of the matrices “a”, “b” and “res”, is practically constant for a very large number of different sizes of these matrices.

Other tests with other source codes implementing other computer processing operations that manipulate matrices were performed. It was able to be observed, for these other processing operations as well, that the ratio, equal to the execution speed of the code 78 by the computing device divided by the sizes of the processed matrices, practically did not vary according to the size of the processed matrices.

### Section II: Variants

Variants of the Computing Device 4:

So far, the embodiment of the compiler 40 has been illustrated in the particular case where the secondary memory is a “Scratchpad” memory. However, what has been described above is applicable to any type of secondary memory. For example, the secondary memory may be an in-memory computing system such as the one described in the following article: Maha Kooli et al.: “Smart instruction codes for in-memory computing architectures compatible with standard sram interfaces”, 2018 Design, Automation & Test in Europe Conference & Exhibition (DATE), pages 1634-1639. IEEE, 2018. Such an in-memory computing system is known for example by the acronym “C-SRAM”. In this case, the optimized coding of the data structure makes it possible to save data of this data structure in this in-memory computing system and therefore to take advantage of the computations performed by this system. Specifically, computing operations between two of the data saved in a C-SRAM may be executed more quickly by the C-SRAM than if the same operations were to be performed in a conventional manner by the microprocessor. In a first embodiment, the compilation method described above is applied in the same way as in the case of a computing device comprising a C-SRAM instead of the memory 34.

In one improved embodiment for C-SRAMs, the coefficient C(D_{k,n}), which represents the benefit of saving a datum D_{k,n} in the secondary memory, is adapted to the case of C-SRAMs. For example, as a variant, the coefficient C(D_{k,n}) is computed such that its value increases as a function of the alignment of the datum D_{k,n} with respect to the adjacent data of the subdivision k. Specifically, to effectively perform in-memory computing operations, the data to be combined with one another have to be located at the same locations in each of the rows of the memory to be combined. If this is not the case, before being able to perform an in-memory computing operation between these two data, at least one of them has to be displaced so as to align with the other datum. The smaller the number of data displacements to be performed before performing an in-memory computing operation, the more quickly the computation performed by the memory is executed. Thus, by way of illustration, in the case of a C-SRAM, the coefficient C(D_{k,n}) may be computed using the following relationship: C(D_{k,n})=Av(D_{k,n})/(L(D_{k,n})Occ(D_{k,n})), where:

the quantities Av(D_{k,n}) and Occ(D_{k,n}) are the same quantities as those defined above,

the quantity L(D_{k,n}) is defined by the following relationship: L(D_{k,n})=f_{c}(@_{k,n})−f_{c}(@_{k,n-1}) where:
@_{k,n} and @_{k,n-1} are the virtual addresses, in the memory 6, respectively, of the data D_{k,n} and D_{k,n-1} of the accessed data structure,
f_{c}(@_{k,n}) is the following operation: f_{c}(@_{k,n})=@_{k,n} mod L, where:
   L is the length, in number of bits, of each row of the C-SRAM,
   “mod” denotes the modulo operation, thus, the term @_{k,n} mod L is equal to the remainder of the Euclidean division of the address @_{k,n} by the length L.

The term @_{k,n} mod L is representative of the distance that separates the datum D_{k,n} corresponding to this address @_{k,n} from the start of the row of the C-SRAM. The difference between the terms f_{c}(@_{k,n}) and f_{c}(@_{k,n-1}) is therefore representative of the alignment of the datum D_{k,n} in relation to the datum D_{k,n-1}. Therefore, the number of shifts to be executed to align these two data is proportional to this difference L(D_{k,n}). If the difference between the terms f_{c}(@_{k,n}) and f_{c}(@_{k,n-1}) is zero, the quantity L(D_{k,n}) is taken to be equal to 0.5.

When the secondary memory is not a memory that it is possible to access more quickly than the memory 22, then the coefficient C(D_{k,n}) does not necessarily depend on the values Av(D_{k,n}) and Occ(D_{k,n}). For example, if the secondary memory is a C-SRAM, the coefficient C(D_{k,n}) may easily be computed using the following relationship: C(D_{k,n})=L(D_{k,n}).

In another embodiment, the secondary memory is not a faster memory, but a memory that consumes less power for example. In this case, typically, the performance of the target computing device that is optimized is power consumption.

Variants of the Compilation Module 64:

As a variant, the original source code is not written in the V0 language, but, for example, in a conventional programming language such as the C++ language or the C language. In this case, according to a first embodiment, the compilation module 64 is modified so as to execute, before operation 108, an operation of specializing the original source code that is provided. In this specializing operation, the compilation module 64 analyzes the source code and automatically introduces into it the specific instructions required to implement the methods described here. For example, to this end, the compilation module 64 automatically replaces the instructions of the C++ language that deal with data structures with the corresponding specific instructions of the V0 language. In particular, the compilation module automatically replaces the portions of the original source code written in C++ language that access the data structures with the corresponding specific instructions of the V0 language. The remainder of the compilation method is then identical to what has been described above.

According to a second embodiment, the module 64 is modified so as to directly transform the original source code written in a conventional language into an instrumented intermediate source code. For example, to this end, the compilation module 64 analyzes the original source code in order to identify the portions of this original source code that deal with data structures. Next, each identified portion is automatically supplemented with the set of instrumentation instructions required to retrieve the access pattern for accessing these data structures. Next, in step 140, it is these same portions of the source code that are each replaced with a coding optimized on the basis of the retrieved access pattern. In this second embodiment, the V0 language is therefore not used.

In another embodiment, the module 64 itself chooses a size for each of the data structures, the sizes of which are known only during the execution of the computer program. For example, for the dimension N0 of the matrix “a”, the module 64 automatically replaces the instruction “cin>>NO” with an instruction “# DEFINE N0 DimN0”, where DimN0 is a predetermined numerical value. The module does the same thing for each of the instructions of the C++ language that allow the sizes of the matrices “a”, “b” and “res” to be acquired. Thus, when the code 76 is executed, the user no longer has to manually enter these sizes.

The above description has been given in the particular case where the standard matrix layout implemented by the compilation module 64 is the row layout. As a variant, the standard layout may be different. For example, the standard layout may be considered to be the column or diagonal layout or the like.

Variants of the Compilation Module 66:

In less refined embodiments, the comparison performed in operation 144 is performed differently. For example, other coefficients of correlation may be used. For example, the coefficients of correlation known as “Kendall's tau rank” or “Spearman's rank” may be used.

As a variant, when selecting the optimized coding for a data structure, the compilation module 66 presents the developer with a restricted list of possible optimized codings. This restricted list comprises only the optimized codings that are associated, by the database 74, with the signature models used to generate the model signatures that are most highly correlated with the signature constructed for this data structure. For example, the restricted list comprises only the optimized codings associated with the model signatures for which the computed coefficient of correlation exceeds a predetermined threshold. Next, the developer selects, from this restricted list, the optimized coding to be used for this data structure. A “restricted list of optimized layouts” is understood here to mean a list that contains a number of optimized codings that may be used for this data structure that is smaller than the total number of optimized codings contained in the database 74 and able to be used for this same data structure.

If the original source code is not written in the V0 language but, for example, in a conventional programming language such as the C++ language or the C language, the compilation module 66 is modified in a manner similar to that which has been described, in the same case, for the compilation module 64. In particular, the module 66 is modified either so as to specialize the original source code by using, for this purpose, instructions of the V0 language or to directly transform the original source code into an optimized source code. For example, in the latter case, the compilation module 66 analyzes the original source code in order to identify the portions of this original source code that allocate memory space to a particular data structure. Next, the identified portion is automatically replaced with the optimized coding that is selected on the basis of the signature of the access operations to this particular data structure.

In operation 150, when the number of additional equations obtained using condition (4) is greater than two, other selection methods are possible so as to retain only 4(NbS0-1) equations. For example, all of the additional equations introduced by condition (4) are retained, and equations introduced by conditions (2) and (3) are eliminated in order to bring the number of equations to 4(NbS0−1).

As a variant, conditions other than conditions (1) to (6) presented above may be used in operation 150 to construct the function P_{S}(x).

As a variant, the data D_{k,n} saved in the same subdivision k are not necessarily accessed one after the other when the computer program is executed. In other words, it is not always necessary to maximize the locality of the data. Therefore, at least in some cases, the selection of an optimized layout that maximizes the locality of the data may be omitted. In this case, the construction of the signatures and then the selection of optimized coding from among a plurality of possible optimized codings may be omitted. Specifically, in one extremely simple embodiment, the database 74 comprises only one optimized coding for each of the instructions of the V0 language. For example, only the optimized codings of the conversion table of annex 7 are used.

In another variant, an optimized layout for the data structure is selected using information other than the retrieved access pattern. For example, in a simplified case, it is the developer who selects the optimized layout to be used himself for each data structure.

Variants of the Module 68 for Retrieving the Access Pattern:

In one variant, the module 68 for retrieving access operations is implemented in the form of a hardware module implemented, for example, in the microprocessor 56. In this case, the executable code does not need to be instrumented to retrieve the access patterns. The hardware module for retrieving access operations functions in the same way as in the case of the software implementation described above. In addition, preferably, in this case, each datum saved in the memory 58 comprises, in addition to the datum itself, the identifier of the data structure to which this datum belongs. The hardware module may thus easily retrieve the identifier of the data structure corresponding to the accessed datum.

As a variant, the retrieving module 68 is modified to retrieve only a read access pattern and/or only a write access pattern. A read access pattern is an access pattern that comprises only the position identifiers of the data of the data structure that are read during the execution of the executable code 76. Conversely, a write access pattern is an access pattern that comprises only the position identifiers of the data of the data structure that are written during the execution of the executable code 76. For example, to retrieve only the read access pattern, no specific instruction is used in the source code to code the write access operations to the data structure. For example, the instructions “MATRIX_SET” and “MATRIX_ADD” are replaced with conventional corresponding instructions of the C++ language in the source code 62.

As a variant, the retrieved position identifier is the virtual address of the accessed datum. In this case, the function f_{t,m} is adapted accordingly. For example, the function f_{t,m} is applied to the retrieved virtual address and no longer to each of the indices xₜ and yₜ. In other possible embodiments, the position identifier is neither an index nor the virtual address of the accessed datum. For example, the retrieved position identifier is the physical address of the datum in the main memory. This is possible for example when no virtual memory mechanism is implemented. Specifically, in such a situation, the physical address range in which the data structure is saved is continuous and comprises only data of this data structure.

Variants of the Module 70 for Constructing a Signature:

In one simplified variant, step 126 of transforming the retrieved access pattern into a transformed access pattern is omitted. In this case, the statistical distribution is for example directly constructed on the basis of the retrieved access pattern. This variant is preferably combined with the case where the retrieved position identifier is an index used to identify the position of the datum accessed within the data structure.

In another simplified embodiment, the constructed statistical distribution is not normalized.

Transformation functions other than the function f_{t,m} may be used instead of the function f_{t,m}. Specifically, there are numerous transformation functions that make it possible to construct a signature characteristic of the temporal order in which the data of the data structure are traversed. For example, the function f_{t,m} may be replaced with a function f_{t,m} defined by the following relationship f_{t,m}(xₜ)=|xₜ−xₜ₋₁|, where the symbol | . . . | denotes the absolute value operation.

Depending on the hardware architecture of the target computing device, the optimized coding of the data structure that makes it possible to improve the execution speed for a particular traversal is not necessarily the same. In particular, an optimized coding may exist only for certain hardware architectures. In this case, the function f_{t,m} is also chosen depending on the hardware architecture of the target computing device. To this end, the module 70 is capable of automatically selecting, from a database, a function f_{t,m} corresponding to the acquired identifier of the hardware architecture of the target computing device. Other examples of a function f_{t,m} for other hardware architectures of target computing devices are described in section II of application FR1913348 filed on Nov. 27, 2019.

Other methods may be used to construct a signature characteristic of access operations to a data structure. One example of another method able to be used is described in the following article: Z. Xu et al.: “Malware detection using machine learning based analysis of virtual memory access patterns”, In DATE, 2017.

Variants of the Database 74:

Instead of containing parameterized signature models, the database 74 may directly contain the model signatures. In this case, typically, for one and the same particular traversal, the database comprises as many model signatures as there are possible sizes for the data structure. This increases the size of the database 74 but, in return, it simplifies the extraction of a model signature from this database. Specifically, it is then no longer necessary to generate this model signature on the basis of a parameterized signature model. In this case, it is also no longer necessary for the module 68 to retrieve the size of the data structure.

In the case of data structures other than two-dimensional matrices, signature models have to be established for each of these data structures. To this end, the same methodology as that described in the case of two-dimensional matrices may be used.

Variants of the Cutting Procedure fCut( ):

As a variant, the dimensions of the various subdivisions of one and the same data structure are not all equal.

If the dimension DimS of the subdivisions is small, the weight w_{S,NbS}(k) associated with a subdivision k may be greater than the dimension DimS. In this case, when data are transferred between the memories 6 and 34, the data of the subdivision k along with data from the subdivisions adjacent to this subdivision k are transferred simultaneously from the memory 6 to the memory 34.

Variant of the Procedure fTdl( ):

Other methods for computing the values of the weights w_{S,NbS0}(k) are possible. For example, other values may be chosen for the parameters So and μ.

It is also possible to use methods other than the AMSC method for grouping the data D_{k,n} into various classes. In this case, preferably, this other method exhibits properties close or identical to those of the AMSC method.

As a variant, the value of the weights w_{S,NbS}(k) is not necessarily an integer multiple of the parameter So. The group G_{w} of values from which the values of the weights w_{S,NbS}(k) are chosen may thus also contain values other than integer multiples of the parameter So. For example, in one particular embodiment, the group G_{w} comprises integer values independent of the value of the parameter So. In the latter case, the parameters So and p are not necessarily used. In another embodiment, the values contained in the group G_{w} do not form an arithmetic series but, for example, a geometric series or the like. For example, the group G_{w} comprises only even multiples of the parameters So.

As a variant, the polynomials P_{S,k}(x) each defined over a respective interval [k; k+1] may be first-order or second-order polynomials, and not necessarily third-Order polynomials. In this case, at least some of conditions (1) to (6) have to be lightened so that the number of equations to be solved corresponds to the number of variables to be determined.

The values of the weights w_{S,NbS0}(k) may be computed by implementing a procedure other than those described above. In particular, it is not necessary to compute the values of the weights w_{S,NbS0}(k) on the basis of the coefficients C(D_{k,n}) as described above. In fact, regardless of the method for computing the values of the weights w_{S,NbS0}(k), and therefore regardless of the value of the weights w_{S,NbS0}(k), the procedure fTdl( ) described here may be implemented in order to compute the value of the weights w_{S,NbS}(k) for other dimensions of the data structure, without having to reiterate the execution of the steps each time, such as steps 112 and 148 for this new size of the data structure. Specifically, computing the weights w_{S,NbS}(k) using the function P_{S}(x) always turns out to be faster and makes it possible to obtain values for the weights that make it possible at least to obtain performances that are practically identical for the computing device 4, and for any possible size of the data structure.

Thus, in another embodiment, the weights w_{S,NbS0}(k) are values chosen by the developer. For example, the developer determines these values experimentally. To this end, the developer may proceed as follows:

Operation 1): the developer chooses a new set of values for each of the weights w_{S,NbS0}(k).

Operation 2): the compiler generates the executable code 78 using the values chosen in operation 1) for the weights w_{S,NbS0}(k).

Operation 3): the performance of the generated code 78 is measured. For example, the execution speed of the code 78 is measured. If the measured performance is better than that obtained with the previous best set of values for the weights w_{S,NbS0}(k), the set of values chosen in operation 1) replaces the previous best set of values.

Operations 1) to 3) are reiterated multiple times until obtaining a set of values for each of the weights w_{S,NbS0}(k) that makes it possible to achieve the desired performance level.

In another embodiment, each time a procedure fTdl( ) is constructed for a particular traversal corresponding to a model signature, this procedure fTdl( ) is saved in the optimized coding associated with this signature model. Thus, when the compiler 40 is used again to compile a second computer program that traverses a data structure following the same path as the one implemented by a first computer program compiled by the compiler 40, this leads to the selection of the same signature model as the one selected previously for the first compiled computer program. Therefore, in this second compilation, the function fTdl( ) does not need to be reconstructed, since it has already been constructed and saved in the conversion table in the first compilation. Thus, in this second compilation, the execution of steps 148,150 and 152 may be omitted.

The “status” field may be saved elsewhere than in the indirection table Tdl. In one particular case, the “status” field may even be simplified. For example, this is possible if each first access instruction for accessing a datum of the data structure systematically causes this datum to be loaded into the memory 34 and each subsequent access instruction for accessing this same datum is systematically executed with a virtual address corresponding to the address of this datum in the memory 34. In other words, in this particular case, the data of the data structure are initially loaded into the memory 34 and remain permanently in this memory 34 for as long as the data structure is used. In such a situation, the “status” field does not need to comprise the information that makes it possible to ascertain whether or not the datum D_{k,n} is already saved in the memory 34. Likewise, in the particular case in which the data saved in the memory 34 are only accessed in read mode, then the “status” field does not need to comprise information indicating that the data have been modified in the memory 34.

Variant of the Transfer Procedure fLoad( ):

Numerous other embodiments of the procedure fLoad( ) are possible. For example, other methods are possible for constructing the block B_{k,l} that contains the datum D_{k,n} to be transferred to the memory 34. For example, each subdivision k is divided into a succession of multiple predetermined successive blocks B_{k,l}. In this case, the index “l” is the order number of the block B_{k,l} in the subdivision k. Each block B_{k,l} comprises w_{S,NbS}(k) data. The data of each block B_{k,l} are all located at immediately consecutive addresses in the memory 6. In this case, the data block B_{k,l} to be transferred to the memory 34 is not constructed on the basis of the datum D_{k,n}.

There are also other methods for selecting the data blocks B_{k,l} to be replaced in the memory 34. For example, the blocks B_{k,l} to be replaced may be selected using the first in first out principle. In such an embodiment, for example, the “status” field of the indirection table additionally comprises, for each block B_{k,l} saved in the memory 34, information representative of the duration of the presence of this block B_{k,l} in the memory 34. For example, the information representative of the duration of the presence of the block B_{k,l} is an index that is incremented by one each time a block of the data structure is transferred to the memory 34. The oldest blocks B_{k,l} in the memory 34 are thus associated with values of this index that are lower than those associated with the blocks transferred more recently to the memory 34.

Variants of the Procedures fGet( ) and fSet( ):

As a variant, the procedures fGet( ) and fSet( ) may vary on the basis of the subdivision k in which the datum to be accessed is contained. This may for example be used to further optimize the transfer of data between the memories 36 and 34, taking into account for this purpose the order number k of the subdivision and therefore the weight w_{S,NbS}(k) associated with this subdivision.

Other Variants:

As a variant, an optimized coding is used for only some of the data structures declared in the source code. For example, to this end, just one or more of the data structures of the source code are accessed using the specific instructions of the V0 language. In this source code, the access operations to the other declared data structures are coded by directly using the corresponding instructions of the C++ language instead of using the specific instructions of the V0 language.

What has been described in the particular case where the data structure is a two-dimensional matrix applies, after adaptation, to any type of data structure. If the data structure is not a two-dimensional matrix, the specific instructions “MATRIX_DEFINE”, “MATRIX_ALLOCATE”, “MATRIX_GET”, “MATRIX_SET”, “MATRIX_FREE” of the V0 language are replaced, respectively, with specific instructions “D_DEFINE”, “D_ALLOCATE”, “D_GET”, “D_SET”, “D_FREE”. These specific instructions starting with “D_” each perform the same function as that described in the particular case where the data structure is a two-dimensional matrix. However, the corresponding set of instructions in C++ language has to be adapted. For example, if the data structure is a one-dimensional matrix, the corresponding set of instructions in C++ language has the specific instruction “D_DEFINE n” and “int *n”. Similarly, if the data structure is a three-dimensional matrix, the corresponding set of instructions in C++ language has the specific instruction “D_DEFINE” and the instruction “int ***n”.

The set of instrumentation instructions also has to be adapted. For example, if the data structure is a matrix with one or with more than three dimensions, the number of indices to be retrieved in each access operation to a datum of this data structure is not the same.

Other embodiments of the V0 language are possible. For example, instead of using the C++ programming language for the instructions other than the specific instructions, other programming languages may be used, such as the C, Ada, Caml or PASCAL language for these other instructions.

In one particular case, the compiled computer program may be the source code of an operating system. An operating system compiled in this way may then use the secondary memory.

The procedure of assigning the weights w_{S,NbS0}(k) described above may be implemented without using the function P_{S}(x) for computing the weights w_{S,NbS}(k) for the same data structure. For example, in one alternative embodiment, the function P_{S}(x) is not used. To this end, for example, the procedure fTdl( ) is identical to the weight assignment procedure used to compute the weights w_{S,NbS0}(k) for the number NbS0 of subdivisions. Therefore, for the size Dim1 of the data structure that corresponds to NbS1 subdivisions, the following operations are executed:

the non-optimized executable code 76 is executed and, when this code 76 is executed, the size Dim1 of the data structure is chosen, and then

the access pattern for accessing the data structure of size Dim1 is retrieved, and then

the weights w_{S,NbS1}(k) are computed by executing step 148 for the number NbS1 of subdivisions and using the access pattern retrieved for this size Dim1.

The above operations may notably be implemented in order to compute the weights w_{S,NbS1}(k) of a data structure whose size is known at the time when the computer program is compiled. In other words, the size Dim1 is not acquired when the computer program is executed.

The procedure of assigning the weights w_{S,NbS0}(k) described above may also be implemented without using the procedure fTdl( ). For example, when the size of the data structure is constant and equal to Dim0, then operations 150, 152 are omitted and, in operation 154, no weight-computing procedure is introduced into the optimized source code. Only the indirection table Tdl0, constructed in operation 148, is introduced into the optimized source code. In this case, the structure of the table Tdl0 is for example similar to that described for the table Tdl.

### Section III: Advantages of the Described Embodiments

Computing the weights w_{S,NbS}(k) using the function P_{S}(x) makes it possible to obtain values for these weights that make it possible to keep the performance of the computing device 4 constant or approximately constant when the dimension chosen for the data structure is different from the dimension Dim0 used to construct the weights w_{S,NbS0}(k). Using the function P_{S}(x) thus makes it possible to keep the performance of the computing device 4 substantially constant, and to do so even if the dimension of the data structure varies.

In addition, computing the weights w_{S,NbS}(k) on the basis of the weights w_{S,NbS0}(k) makes it possible to quickly determine the values of these weights for any dimension of the data structure. This turns out to be faster than reiterating the various operations implemented to compute the weights w_{S,NbS0}(k), but in the case where the size of the data structure is different.

The fact that the function P_{S}(x) satisfies conditions (1) to (4) makes it possible to obtain values for the weights w_{S,NbS}(k) that make it possible to replicate, practically without any variation in performance, the performance obtained for the size Dim0 of the data structure in any other dimension of this data structure.

The fact that the weight w_{S,NbS0}(k) is computed using the relationship w_{S.NbS0}(k)=F(C(D_{k,l}), . . . , C(D_{k,Dimk})) makes it possible to speed up the execution of the computer program when the secondary memory is a faster memory than the main memory or than the cache memory.

Selecting the procedure fCut( ) on the basis of the retrieved access pattern in operation 146 makes it possible to systematically choose a layout for the data structure in the main memory that improves the locality of the data. The improvement in the locality of the data reduces the number of data transfers between the memories 6 and 34. This improves the execution speed of the computer program.

Choosing the weights w_{S,NbS0}(k) to each be equal to an integer multiple of the parameter So makes it possible to speed up the transfer of data between the memories 6 and 34.

Using the AMSC grouping procedure makes it possible to reserve use of the memory 34 for data of the data structure for which it is highly likely that this is beneficial. This thus also makes it possible to limit the number of data transfers between the memories 6 and 34, and therefore to speed up the execution of the computer program by the computing device 4.

Systematically choosing a layout that limits the number of cache errors for each data structure additionally makes it possible to maximize the probability of the various data contained in one and the same subdivision being accessed one after the other. This therefore also increases the probability of the data preloaded into the memory 34 subsequently being accessed by the computer program. This therefore also makes it possible to limit the number of data transfers between the memories 6 and 34 and therefore to speed up the execution of the computer program.

The use of a signature characteristic of the access operations specific to a single data structure as a signature characteristic of the access operations to the memory makes it possible to obtain a more reproducible characteristic signature. In particular, the characteristic signature thus constructed is more reproducible than a characteristic signature constructed taking into account all of the access operations to the memory and without distinguishing between access operations to a data structure and other access operations to the memory.

In addition, the fact that the signature is constructed on the basis of relative position identifiers and not directly on the basis of the virtual or physical addresses makes it possible to obtain a signature that depends only on the way in which the data of the data structure are traversed when the computer program is executed. The constructed signature is thus practically independent of the other characteristics of the computer program that is executed. For example, the constructed signatures obtained by executing two computer programs that are different but that access the data structure using the same particular traversal are identical.

The use of relative position identifiers also makes the constructed signature insensitive to modification of the virtual or physical address range allocated to this data structure. Specifically, it is common, in a subsequent execution of the same computer program, for the operating system to allocate a different virtual or physical address range to the same data structure.

By virtue of the fact that the statistical distribution is normalized, it matters little that one computer program reiterates the same processing operations on the data structure numerous times while another computer program executes these processing operations only once. If these two programs traverse the data structure in the same way, the signatures constructed for these two programs will be identical or very similar.

The fact that the relative position identifier is equal to the distance between two successively retrieved position identifiers makes it possible to obtain a transformed access pattern representative of the order in which the various data of the data structure are accessed.

The fact that the constructed signature comprises a statistical distribution for each index makes it possible to obtain a signature that is more distinctive than if the virtual addresses were to be used.

The construction of the signature characteristic of the access operations to the memory, using for this purpose not physical addresses but the indices or the virtual addresses in the address space of the computer program of the accessed data, makes it possible to obtain a signature that is independent:

of the operating system executed by the computing device that executes the computer program, and

of the layout of the data structure in the memory of the computing device.

### ANNEXES

Annex 1: Example of source code in V0 language

| | |
|---|---|
| 1 | |
| 2 | |
| 3 | #d e f i n e TYPE i n t |
| 4 | |
| 5 | |
| 6 | v o i d m a t r i x Mul t ( ) |
| 7 | { |
| 8 | int N0; |
| 9 | int N1; |
| 10 | int N2; |
| 11 | cin >> N0 >> N1; |
| 12 | cin >> N2; |
| 13 | MATRIX_DEFINE(TYPE, a ) ; |
| 14 | MATRIX_DEFINE(TYPE, b ) ; |
| 15 | MATRIX_DEFINE(TYPE, r e s ) ; |
| 16 | |
| 17 | MATRIX_ALLOCATE(TYPE, N0 , N1 , a ) ; |
| 18 | |
| 19 | |
| 20 | |
| 21 | MATRIX_ALLOCATE(TYPE, N2 , N0 , b) ; |
| 22 | |
| 23 | |
| 24 | |
| 25 | MATRIX_ALLOCATE(TYPE, N2 , N1 , r e s ) ; |
| 26 | |
| 27 | |
| 28 | |
| 29 | for ( i n t j =0; j<N1 ; j++) |
| 30 | { |
| 31 | for ( i n t i =0; i<N2 ; i++) |
| 32 | { |
| 33 | MATRIX_SET( r e s, i, j, 0) ; |
| 34 | for(i n t k=0; k<N0 ; k++) |
| 35 | { |
| 36 | i n t tmp_a = MATRIX_GET( a , k , j ) ; |
| 37 | i n t tmp_b = MATRIX_GET( b , i , k) ; |
| 38 | MATRIX_ADD( r e s, i, j, tmp_a*tmp_b); |
| 39 | } |
| 40 | } |
| 41 | } |
| 42 | |
| 43 | MATRIX_FREE( a, N0 , N1 , TYPE) ; |
| 44 | |
| 45 | |
| 46 | MATRIX_FREE( b, N2 , N0 , TYPE) ; |
| 47 | |
| 48 | |
| 49 | MATRIX_FREE( r e s, N2 , N1 , TYPE); |
| 50 | } |

Annex 2: Example of optimized
intermediate source code in C++ language

| | |
|---|---|
| 1 | |
| 2 | |
| 3 | |
| 4 | #d e f i n e TYPE i n t |
| 5 | |
| 6 | |
| 7 | v o i d m a t r i x Mul t ( ) |
| 8 | { int N0; |
| 10 | int N1; |
| 11 | int N2; |
| 12 | cin >> N0 >> N1; |
| 13 | cin >> N2; |
| 14 | i n t ** a ; |
| 15 | i n t ** b ; |
| 16 | i n t ** r e s ; |
| 17 | |
| 18 | a = ( i n t **) m a l l o c (N1 * s i z e o f ( i n t *) ) ; |
| 19 | f o r ( i n t i=0;i <( i n t )N1 ; i++) |
| 20 | a [ i ] = ( i n t *) m a l l o c (N0* s i z e o f ( i n t ) ) ; |
| 21 | |
| 22 | b = ( i n t **) m a l l o c (N2 *s i z e o f ( i n t *) ) ; |
| 23 | f o r (i n t i=0;i <( i n t )N2 ; i++) |
| 24 | b [ i ] = ( i n t *) m a l l o c (N0* s i z e o f ( i n t ) ) ; |
| 25 | |
| 26 | r e s = ( i n t **) m a l l o c (N1 * s i z e o f ( i n t * ) ) ; |
| 27 | f o r (i n t i=0; i< ( i n t )N1 ; i++) |
| 28 | r e s [ i ] = ( i n t * ) m a l l o c (N2* s i z e o f ( i n t ) ); |
| 29 | |
| 30 | f o r (i n t j =0; j<N1 ; j++) |
| 31 | { |
| 32 | f o r (i n t i =0; i<N2 ; i++) |
| 33 | { |
| 34 | r e s [ j ] [ i ] = 0 ; |
| 35 | f o r (i n t k=0; k<N0 ; k++) |
| 36 | { |
| 37 | i n t tmp_a = a [ j ] [ k ] ; |
| 38 | i n t tmp_b = b [ i ] [ k ] ; |
| 39 | r e s [ j ] [ i ] += tmp_a*tmp_b ; |
| 40 | } |
| 41 | } |
| 42 | } |
| 43 | |
| 44 | f o r ( i n t i =0; i <( i n t )N0 ; i++) f r e e ( a [ i ] ) ; |
| 45 | f r e e ( a ) ; |
| 46 | |
| 47 | f o r (i n t i =0; i <( i n t )N2 ; i++) f r e e ( b [ i ] ) ; |
| 48 | f r e e ( b ) ; |
| 49 | |
| 50 | f o r (i n t i =0; i <( i n t )N2 ; i++) f r e e ( res [ i ] ) ; |
| 51 | f r e e ( res ) ; |
| 52 | |
| 53 | } |

Annex 3: Signature model of traversal P1

| | |
|---|---|
| 1 | # Occurrence X |
| 2 | deltaX = [−dimX+1, 1 ] |
| 3 | occDeltaX = [ dimY−1, dimY*( dimX−1) ] |
| 4 | |
| 5 | # Occurrence Y |
| 6 | deltaY = [ 0 , 1 ] |
| 7 | occDeltaY = [ dimY*( dimX−1) , dimY−1] |

Annex 4: Signature model of traversal P2

| | |
|---|---|
| 1 | # Occurrence X |
| 2 | deltaX = [ 0 , 1 ] |
| 3 | occDel taX = [ dimX*( dimY−1) , dimX−1] |
| 4 | |
| 5 | # Occurrence Y |
| 6 | occDeltaY = [−dimY+1, 1 ] |
| 7 | occDeltaY = [ dimX−1, dimX*( dimY−1) ] |

Annex 5: Signature model of traversal P3

| | |
|---|---|
| 1 | d iag = math.sqrt( dimX**2 + dimY**2) |
| 2 | dim = min(dimX, dimY) |
| 3 | peack = dimX*dimY + 1 − ( dimX + dimY) |
| 4 | |
| 5 | # Occurrence X |
| 6 | deltaX = [ i for i in range(−dim+2, 2) ] |
| 7 | occDeltaX = [ 2 for i in range(−dim+2, 0) ] |
| 8 | occDeltaX.append(peack ) |
| 9 | |
| 10 | # Occurrence Y |
| 11 | deltaY = [ i for i in range (−dim+1, 2) ] |
| 12 | occDeltaY = [ 2 for i in range(−dim+2, 0) ] |
| 13 | occDeltaY.append ( 0 ) |
| 14 | occDeltaY.append ( peack ) |
| 15 | |
| 16 | if (dimX < dimY) : |
| 17 | occDeltaX.insert(0 , dimY−dimX) |
| 18 | occDeltaY.insert(0 , dimY−dimX) |
| 19 | else: |
| 20 | occDeltaX.insert(0 , dimX−dimY + 2) |
| 21 | occDeltaY.insert(0 , dimX−dimY + 2) |

Annex 6: Signature model of traversal P4

| | |
|---|---|
| 1 | t otalOcc = dimY * dimX−1 |
| 2 | |
| 3 | # Occurrence X |
| 4 | de lt aX = [−dimX+1] |
| 5 | occDeltaX = [nbBlock_Y_ceil −1 ] |
| 6 | tota Occ −= occDeltaX [−1] |
| 7 | |
| 8 | occurrence1 = ( dimX−1) * nbBlock_Y_ceil |
| 9 | totalOcc −= ocurence1 |
| 10 | |
| 11 | delt aX . append ( 0 ) |
| 12 | occDel taX . append ( t o t a lOc c ) |
| 13 | |
| 14 | deltaX.append( 1 ) |
| 15 | occDeltaX.append(ocurence1 ) |
| 16 | |
| 17 | # Occurrence Y |
| 18 | totalOcc = dimY * dimX−1 |
| 19 | |
| 20 | deltaY = [ 1 −dimY_block ] |
| 21 | occDeltaY = [ ( dimX −1) * nbBlock_Y ] |
| 22 | totalOcc −= occDeltaY[−1] |
| 23 | |
| 24 | if ( remainBlock_Y > 0) : |
| 25 | deltaY.append (1 − remainBlock_Y ) |
| 26 | occDeltaY.append (dimX −1) |
| 27 | totalOcc = occDeltaY [−1] |
| 28 | |
| 29 | deltaY.append(1) |
| 30 | occDeltaY.append(totalOcc) |

Annex 7: Generic optimized coding associated with the signature model of traversal P1

| Specific instructions in VO language | Generic code in C++ language |
|---|---|
| MATRIX_DEFINE(TYPE, NAME) | TYPE **NAME; |
| MATRIX_ALLOCATE(TYPE, NBL, NBC, | fCut(TYPE, NBL, NBC, NAME) |
| NAME) | { |
| | NAME =(TYPE **)malloc(NBC * sizeof(TYPE*)); |
| | for (int i=0; i<(int)NBC; i++) |
| | NAME[i]=(TYPE *)malloc(NBL*sizeof(TYPE)); |
| | ... |
| | } |
| | fTdl(NbS); |
| MATRIX_GET(NAME, NDL, NDC) | fGet(NAME, NDL, NDC) |
| | { |
| | ... |
| | fLoad(NAME, NDL, NDC); |
| | } |
| MATRIX_SET(NAME, NDL, NDC, VALUE) | fSet(NAME, NDL, NDC, VALUE) |
| | { |
| | ... |
| | fLoad(NAME, NDL, NDC); |
| | } |
| MATRIX_ADD(NAME, NDL, NDC, | VALUE = VALUE + fGet(NAME, NDL, NDC); |
| VALUE) | fSet(NAME, NDL, NDC, VALUE); |
| MATRIX_FREE(NAME, NBL, NBC, TYPE) | fFree(NAME, NBL, NBC) |
| | { |
| | for (int i=0; i<(int)NBL; i++) free(NAME[i]); |
| | free(NAME); |
| | ... |
| | } |

Annex 8: Optimized layout associated with the signature model of traversal P2

| Specific instructions in V0 language | Generic code in C++ language |
|---|---|
| MATRIX_DEFINE(TYPE, NAME) | TYPE **NAME; |
| MATRIX_ALLOCATE(TYPE, NBL, NBC, | fCut(TYPE, NBL, NBC, NAME) |
| NAME) | { |
| | NAME =(TYPE **)malloc(NBL * sizeof(TYPE*)); |
| | for (int i=0; i<(int)NBL; i++) |
| | NAME[i]=(TYPE *)malloc(NBC*sizeof(TYPE)); |
| | ... |
| | } |
| | fTdl(NbS); |
| MATRIX_GET(NAME, NDL, NDC) | fGet(NAME, NDL, NDC) |
| | { |
| | ... |
| | fLoad(NAME, NDL, NDC); |
| | }; |
| MATRIX_SET(NAME, NDL, NDC, VALUE) | fSet(NAME, NDL, NDC, VALUE) |
| | { |
| | ... |
| | fLoad(NAME, NDL, NDC); |
| | }; |
| MATRIX_ADD(NAME, NDL, NDC, | VALUE = VALUE + fGet(NAME, NDL, NDC); |
| VALUE) | fSet(NAME, NDL, NDC, VALUE); |
| MATRIX_FREE(NAME, NBL, NBC, TYPE) | fFree(NAME, NBL, NBC) |
| | { |
| | for (int i=0; i<(int)NBL; i++) free(NAME[i]); |
| | free(NAME); |
| | ... |
| | } |

Annex 9: Optimized layout associated with the signature model of traversal P3

| Specific instructions in V0 language | Generic code in C++ language |
|---|---|
| MATRIX_DEFINE(TYPE, NAME) | TYPE **NAME; |
| MATRIX_ALLOCATE(TYPE, NBL, NBC, | fCut(TYPE, NBL, NBC, NAME) |
| NAME) | { |
| | NAME =(TYPE **)malloc((NBL + NBC+1)* sizeof(TYPE*)); |
| | for (int i=0; i<(int)(NBL + NBC+1); i++) |
| | {NAME[i]=(TYPE *)malloc((NBL + NBC+1) * sizeof(TYPE))}; |
| | ... |
| | } |
| | fTdl(NbS); |
| MATRIX_GET(NAME, NDL, NDC) | fGet(NAME, NDL, NDC) |
| | { |
| | ... |
| | fLoad(NAME, NDL, NDC); |
| | }; |
| MATRIX_SET(NAME, NDL, NDC, VALUE) | fSet(NAME, NDL, NDC, VALUE) |
| | { |
| | ... |
| | fLoad(NAME, NDL, NDC); |
| | }; |
| MATRIX_ADD(NAME, NDL, NDC, | VALUE = VALUE + fGet(NAME, NDL, NDC); |
| VALUE) | fSet(NAME, NDL, NDC, VALUE); |
| MATRIX_FREE(NAME, NBL, NBC, TYPE) | fFree(NAME, NBL, NBC) |
| | { |
| | for (int i=0; i<(int)NBL; i++) free(NAME[i]); |
| | free(NAME); |
| | ... |
| | } |

1. A method for the execution of a computer program by an electronic computing device comprising a main memory and a secondary memory physically distinct from the main memory, said secondary memory corresponding, in the address space of the computer program, to an address range distinct from the address range corresponding to the main memory, wherein said method comprises:
a) providing the executable code of the computer program, said executable code containing:
a declaration of a data structure whose size is acquired only during the execution of the computer program,
access instructions for accessing the data of the data structure,
a predetermined procedure of cutting this said data structure into a number of subdivisions that depends on the size of the data structure, each subdivision comprising a plurality of data each corresponding to a respective address of the address space of the computer program and the addresses of the data of one and the same subdivision all being consecutive, said procedure being capable of ordering the subdivisions in relation to one another in the main memory and of dividing the area of the main memory containing the data structure into NbS0 subdivisions when the size of the data structure is equal to Dim0,
a predetermined procedure of computing weights that is capable, when it is executed by the computing device, of computing a weight for a given number of subdivisions, said procedure using for said purpose a numerical function P_{S}(x) that is continuous over the interval [1; NbS0] and passing through NbS0 points of coordinates (k₀, w_{S,NbS0}(k₀)), said numerical function P_{S}(x) being defined over each interval [k₀, k₀+1] by a polynomial of order less than or equal to three, where:
k₀ is an integer order number contained in the interval [1; NbS0] and identifying a respective subdivision from among the set of NbS0 subdivisions generated by the predetermined cutting procedure when the size of the data structure is equal to Dim0, and
w_{S,NbS0}(k₀) is a weight equal to the number of data transferred between the main memory and the secondary memory in response to the execution, by the computing device, of an access instruction for accessing a single datum of the subdivision corresponding to said identifier k₀, the value of the weight w_{S,NbS0}(k₀) being a constant computed when the computer program is compiled for reaching a given performance level when the dimension of the data structure is equal to Dim0, a procedure of transferring data between the main memory and the secondary memory,
b) execution of the executable code of the computer program by the computing device, during said execution:
the computing device acquires a size Dim1 for the data structure different from the size Dim0, and then
the computing device executes the predetermined cutting procedure parameterized with the acquired size Dim1 and divides the area of the main memory wherein the data structure is saved into NbS1 subdivisions, and then
the computing device executes the predetermined procedure of computing weights parameterized by the number NbS1 of subdivisions, during the execution of the predetermined procedure of computing weights, the weight w_{S,NbS1}(k) for each of the NbS1 subdivisions is obtained using the following relationship: w_{S,NbS1}(k)=P_{S}(1+(k−1)×(NbS0−1)/(NbS1−1)), where the order number k of the subdivision in said case varies between [1; NbS1], and then
when a datum D_{k,n} contained in a subdivision k of the main memory has to be transferred from the main memory to the secondary memory, the computing device executes the transfer procedure, which causes the transfer, to the second memory, of a block of w_{S,NbS1}(k) contiguous data containing the datum D_{k,n} to be transferred, where w_{S,NbS1}(k) is the weight computed for said subdivision k.

2. The method as claimed in claim 1, wherein:
the equation of the numerical function P_{S}(x), between each pair of consecutive points of coordinates [k₀; w_{S,NbS0}(k₀)] and [k₀+1; w_{S,NbS0}(k₀+1)], is a third-order polynomial P_{S,k0}(x) defined only over the interval [k₀; k₀+1], and
the numerical function P_{S}(x) has the following properties:
for each abscissa point k₀ that is located at the limit of two intervals [k₀−1; k₀] and [k₀; k₀+1] on which the polynomials P_{S,k0}(x) and P_{S,k0}(x) are respectively defined, the first and second derivatives of the polynomials P_{S,k0-1}(x) and P_{S,k0}(x) are equal at the abscissa point k₀, and
when the function P_{S}(x) comprises a local extremum, said extremum is located at an abscissa point k₀.

3. The method as claimed in claim 1, wherein each weight w_{S,NbS0}(k₀) satisfies the following relationship:
w_{S,NbS0}(k₀)=F(C_{S,NbS0}(D_{k0,1}), . . . ,C(D_{k0,n-1}),C(D_{k0,n}), . . . ,C(D_{k0,Dimk})), where:
F( ) is a predetermined increasing function, i.e. a function that increases as soon as any one of the coefficients C(D_{k0,n}) increases,
Dimk is the number of data contained in the subdivision k₀,
n is an order number identifying the nth datum D_{k0,n} of the subdivision k₀,
C(D_{k0,n}) is a coefficient defined by the following relationship: C(D_{k0,n})=Av(D_{k0,n})/Occ(D_{k0,n}), where:
Av(D_{k0,n}) is the average number of access operations to other data of the data structure between two consecutive access operations to the datum D_{k0,n} during the execution of the computer program for the size Dim0 of the data structure, and
Occ(D_{k,0n}) is the number of times that the datum D_{k0,n} has been accessed during the execution of the executable code for the size Dim0 of the data structure.

4. A method for compiling a source code of a computer program for a computing device comprising a main memory and a secondary memory physically distinct from the main memory, said secondary memory corresponding, in the address space of the computer program, to an address range distinct from the address range corresponding to the main memory, said method comprising the following step:
a) acquiring an initial source code of the computer program, said source code containing:
a declaration of a data structure whose size is acquired only during the execution of the computer program, and
access instructions for accessing the data of the data structure,
wherein the method also comprises the following steps:
b) the compiler selects a predetermined procedure of cutting said data structure into a number of subdivisions that depends on the size of the data structure, each subdivision comprising a plurality of data each corresponding to a respective address of the address space of the computer program and the addresses of the data of one and the same subdivision all being consecutive, aid procedure being capable of ordering the subdivisions in relation to one another in the main memory and of dividing the area of the main memory containing the data structure into NbS0 subdivisions when the size of the data structure is equal to Dim0,
c) the compiler associates a weight w_{S,NbS0}(k₀) with each of the subdivisions of the data structure of size Dim0 by executing a predetermined weight assignment procedure, where k₀ is an integer order number contained in the interval [1; NbS0] and identifying a respective subdivision from among the set of NbS0 subdivisions generated by the predetermined cutting procedure when the size of the data structure is equal to Dim0, and then
d) the compiler constructs a numerical function P_{S}(x) that is continuous over the interval [1; NbS0] and that passes through each of the points of coordinates (k₀, w_{S,NbS0}(k₀)), said numerical function P_{S}(x) being defined over each interval [k₀, k₀+1] by a polynomial of order less than or equal to three, and then
e) the compiler constructs a procedure of computing weights that is capable, when it is executed by the computing device, of computing a weight w_{S,NbS1}(k) for a given number NbS1 of subdivisions using the following relationship: w_{S,NbS1}(k)=P_{S}(1+(k−1)(NbS0−1)/(NbS1−1)), where k is the order number of the subdivision and in said case varies between [1; NbS1], NbS1 is a number of subdivisions different from the number NbS0 and the function P_{S}( ) is the function constructed in step d),
f) the compiler modifies the initial source code by integrating into it:
the selected procedure of cutting the data structure,
the constructed procedure of computing weights,
a procedure of transferring data between the main memory and the secondary memory that is executed, by the computing device, each time a datum D_{k,n} contained in a subdivision k of the main memory has to be transferred to the secondary memory, said transfer procedure being capable, when it is executed by the computing device, of causing the transfer, to the secondary memory, of a block of w_{S,N}si(k) contiguous data containing the datum D_{k,n} to be transferred, where w_{S,NbS1}(k) is the weight computed for said subdivision k using the constructed procedure of computing weights, and then
g) the compiler compiles the modified source code in order to obtain an executable code that, when it is executed by the computing device, implements the method of claim 1.

5. The method as claimed in claim 4, wherein:
the compiler compiles the initial source code a first time in order to obtain a first executable code, and then
the compiler executes the first executable code and, during said execution of the first executable code:
the compiler acquires a size Dim0 for the data structure, and
upon each access operation to a datum of the data structure, the compiler retrieves the identifier of the data structure and an identifier of the position of the datum accessed within said data structure, the temporally ordered series of just the position identifiers retrieved with the identifier of said data structure forming a retrieved access pattern for accessing said data structure.

6. The method as claimed in claim 5, wherein, in step b), the compiler selects the predetermined cutting procedure depending on the retrieved access pattern.

7. The method as claimed in claim 6, for a computing device that additionally comprises a cache memory, wherein:
in step a), the declaration of the data structure corresponds to a data structure capable of being saved in the main memory of the target computing device according to a standard layout and, alternately, according to an optimized layout, the optimized layout corresponding to a layout of the data of the data structure in the main memory that, when the target computing device traverses the data of said data structure in a particular order, causes fewer cache errors than when, with everything else being the same, it is the standard layout that is implemented, and
the method comprises providing a database from which a model signature of the access operations to said data structure is able to be extracted, said model signature being identical to the one obtained when the computing device executes a computer program that traverses the data of said data structure in said particular order, each model signature being associated, by said database, with a respective predetermined procedure of cutting said data structure, and then
the compiler constructs a signature characteristic of the access operations to the data structure using, for said purpose, only the retrieved access pattern for accessing said data structure, and then
the compiler compares the constructed signature with the model signature extracted from the database, and then
when the model signature corresponds to the constructed signature, the compiler selects the predetermined cutting procedure associated, by the database, with said model signature and, if it does not, selects another predetermined procedure of cutting the data structure.

8. The method as claimed in claim 5, wherein:
the compiler, on the basis of the retrieved access pattern and for each datum D_{k0,n} of the data structure of size Dim0, computes a coefficient C(D_{k0,n}) that increases as a function of a quantity Av(D_{k0,n}) and that decreases as a function of a quantity Occ(D_{k0,n}), where:
the index k₀ is the order number of the subdivision k₀,
the index n is an order number identifying the nth datum D_{k0,n} of the subdivision k₀,
Av(D_{k0,n}) is the average number of access operations to other data of the data structure between two consecutive access operations to the datum D_{k0,n} during the execution of the first executable code for the size Dim0 of the data structure,
Occ(D_{k0,n}) is the number of times that the datum D_{k0,n} has been accessed during the execution of the first executable code for the size Dim0 of the data structure, and then
the compiler computes, for each subdivision k₀ of the data structure of size Dim0, a weight w_{S,NbS0}(k₀) using the following relationship: w_{S,NbS0}(k₀)=F(C_{S,NbS0}(D_{k0,1}), . . . , C(D_{k0,n-1}), C(D_{k0,n}), . . . , C(D_{k0,Dimk})), where:
F( ) is an increasing function, i.e. a function that increases as soon as any one of the coefficients C(D_{k0,n}) increases, and
Dimk is the number of data D_{k0,n} contained in the subdivision k₀.

9. The method as claimed in claim 8, wherein, in step c):
the compiler executes a procedure of grouping the data D_{k0,n} of the data structure of size Dim0 into a plurality of classes as a function of the coefficients C(D_{k0,n}),
the compiler assigns, to each datum D_{k0,n} grouped into one and the same class, one and the same intermediate weight wi_{S,NbS0}(D_{k0,n}), the value of said intermediate weight wi_{S,NbS0}(D_{k0,n}) being greater the greater the median value of the coefficients C(D_{k0,n}) associated with the data D_{k0,n} grouped into this said class, and then
the compiler assigns a weight w_{S,NbS0}(k₀) to each subdivision k₀ of the structure of size Dim0, the value of which is greater the greater the arithmetic mean of the intermediate weights wi_{S,NbS0}(D_{k0,n}) associated with each of the data D_{k0,n} contained in this aid subdivision k₀.

10. The method as claimed in claim 9, wherein, when the grouping procedure is executed, the compiler determines the number of classes and the scope of each class itself on the basis of the coefficients C(D_{k0,n}) associated with each of the data D_{k0,n} of the data structure of size Dim0.

11. The method as claimed in claim 10, wherein the grouping procedure that is executed is the AMSC (“Agglomerative Mean-Shift Clustering”). procedure.

12. The method as claimed in claim 4, wherein, in step c), the compiler assigns a value contained in a group G_{w} consisting only of integer multiples of a parameter So to each weight w_{S,NbS0}(k₀), where the parameter So is equal to the maximum number of data able to be transferred simultaneously on the data bus that connects the main memory to the secondary memory.

13. The method as claimed in claim 12, wherein the values contained in the group G_{w} form a rational arithmetic sequence So.

14. An information storage medium, able to be read by a microprocessor, wherein said medium comprises instructions for executing a method as claimed in claim 1, when these instructions are executed by the microprocessor.

15. An electronic compiler for compiling a source code of a computer program for a computing device comprising a main memory and a secondary memory physically distinct from the main memory, said secondary memory corresponding, in the address space of the computer program, to an address range distinct from the address range corresponding to the main memory, said compiler being configured so as to execute the following step:
a) acquiring an initial source code of the computer program, said source code containing:
a declaration of a data structure whose size is acquired only during the execution of the computer program, and
access instructions for accessing the data of the data structure,
wherein the compiler is also configured so as to perform the following steps:
b) the compiler selects a predetermined procedure of cutting said data structure into a number of subdivisions that depends on the size of the data structure, each subdivision comprising a plurality of data each corresponding to a respective address of the address space of the computer program and the addresses of the data of one and the same subdivision all being consecutive, said procedure being capable of ordering the subdivisions in relation to one another in the main memory and of dividing the area of the main memory containing the data structure into NbS0 subdivisions when the size of the data structure is equal to Dim0,
c) the compiler associates a weight w_{S,NbS0}(k₀) with each of the subdivisions of the data structure of size Dim0 by executing a predetermined weight assignment procedure, where k₀ is an integer order number contained in the interval [1; NbS0] and identifying a respective subdivision from among the set of NbS0 subdivisions generated by the predetermined cutting procedure when the size of the data structure is equal to Dim0, and then
d) the compiler constructs a numerical function P_{S}(x) that is continuous over the interval [1; NbS0] and that passes through each of the points of coordinates (k₀, w_{S,NbS0}(k₀)), die mid numerical function P_{S}(x) being defined over each interval [k₀, k₀+1] by a polynomial of order less than or equal to three, and then
e) the compiler constructs a procedure of computing weights that is capable, when it is executed by the computing device, of computing a weight w_{S,NbS1}(k) for a given number NbS1 of subdivisions using the following relationship: w_{S,NbS1}(k)=P_{S}(1+(k−1)(NbS0−1)/(NbS1−1)), where k is the order number of the subdivision and in said case varies between [1, NbS1], NbS1 is a number of subdivisions different from the number NbS0 and the function P_{S}( ) is the function computed in step d),
f) the compiler modifies the initial source code by integrating into it:
the selected procedure of cutting the data structure,
the constructed procedure of computing weights,
a procedure of transferring data between the main memory and the secondary memory that is executed, by the computing device, each time a datum D_{k,n} contained in a subdivision k of the main memory has to be transferred to the secondary memory, said transfer procedure being capable, when it is executed by the computing device, of causing the transfer, to the secondary memory, of a block of w_{S,NbS1}(k) contiguous data containing the datum D_{k,n} to be transferred, where w_{S,NbS}l(k) is the weight computed for said subdivision k using the constructed procedure of computing weights, and then
g) the compiler compiles the modified source code in order to obtain an executable code that, when it is executed by the computing device, implements the method of claim 1.
